(19) United States
(12) Patent Application Publication
(10) Pub. No.: US 2024/0413312 A1
(43) Pub. Date: Dec. 12, 2024

(54) CARBON POWDER CONTAINING LITHIUM IRON PHOSPHATE CATHODE MATERIALS

(71) Applicant: Aspen Aerogels, Inc., Northborough, MA (US)

(72) Inventors: Hooman YAGHOOBNEJAD ASL, Hudson, MA (US); Redouane BEGAG, Hudson, MA (US); Rushi SONI, Shrewsbury, MA (US); Nicholas LEVENTIS, Worcester, MA (US); Joshua BARTELS, Northborough, MA (US)

(21) Appl. No.: 18/697,708

(22) PCT Filed: Mar. 30, 2023
(86) PCT No.: PCT/US23/16845

§ 371 Date: Apr. 1, 2024

Related U.S. Application Data
(60) Provisional application No. 63/326,353, filed on Apr. 1, 2022.
(60) Provisional application No. 63/336,640, filed on Apr. 29, 2022.
(60) Provisional application No. 63/352,571, filed on Jun. 15, 2022.
(60) Provisional application No. 63/378,756, filed on Oct. 7, 2022.
(60) Provisional application No. 63/416,996, filed on Oct. 18, 2022.
(60) Provisional application No. 63/381,666, filed on Oct. 31, 2022.
(60) Provisional application No. 63/381,672, filed on Oct. 31, 2022.
(60) Provisional application No. 63/381,681, filed on Oct. 31, 2022.
(60) Provisional application No. 63/381,687, filed on Oct. 31, 2022.
(60) Provisional application No. 63/381,694, filed on Oct. 31, 2022.
(60) Provisional application No. 63/381,771, filed on Nov. 1, 2022.
(60) Provisional application No. 63/381,777, filed on Nov. 1, 2022.

(51) Int. Cl. H01M 4/36; C01B 25/45; C01B 32/05; H01M 4/02; H01M 4/58; H01M 4/587

(52) U.S. Cl. CPC H01M 4/366; C01B 25/45; C01B 32/05; H01M 4/5825; H01M 4/587; C01P 2004/03; C01P 2004/61; C01P 2004/62; C01P 2004/64; C01P 2004/80; C01P 2006/12; C01P 2006/16; C01P 2006/40; H01M 2004/028

(57) ABSTRACT

Conglomerate particles comprising a porous carbon matrix with a plurality of cathode material particles at least partially embedded in the matrix are disclosed, as well as methods for their manufacture using predominantly aqueous chemistry. The conglomerate particles demonstrate surprisingly improved electrochemical properties when used as cathode materials as compared to the cathode material particles when non-embedded.

### CROSS REFERENCES TO RELATED APPLICATIONS

This application claims priority to and the benefit of U.S. Provisional Patent Application No. 63/381,777, filed Nov. 1, 2022, U.S. Provisional Patent Application No. 63/381,771, filed Nov. 1, 2022, U.S. Provisional Patent Application No. 63/381,694, filed Oct. 31, 2022, U.S. Provisional Patent Application No. 63/381,687, filed Oct. 31, 2022, U.S. Provisional Patent Application No. 63/381,681, filed Oct. 31, 2022, U.S. Provisional Patent Application No. 63/381,672, filed Oct. 31, 2022, U.S. Provisional Patent Application No. 63/381,666, filed Oct. 31, 2022, U.S. Provisional Patent Application No. 63/416,996, filed Oct. 18, 2022, U.S. Provisional Patent Application No. 63/378,756, filed Oct. 7, 2022, U.S. Provisional Patent Application No. 63/352,571, filed Jun. 15, 2022, U.S. Provisional Patent Application No. 63/336,640, filed Apr. 29, 2022, and U.S. Provisional Patent Application No. 63/326,353, filed Apr. 1, 2022, each of which is herein incorporated by reference in its entirety.

### TECHNICAL FIELD

The present disclosure relates to improved cathode materials for lithium-ion batteries. In particular, the present disclosure relates to porous carbon matrix materials including carbon aerogels, doped with cathode materials, and methods for their manufacture.

### BACKGROUND

One of the most common forms of rechargeable battery is the lithium-ion battery (LIB). LIBs have seen widespread use in a variety of applications, from handheld electronics to automobiles. LIBs are a type of battery in which lithium ions travel from an anode to a cathode during discharge and from the cathode to the anode during the charge cycle (recharging). Conventionally, the anode of LIBs is formed of graphite and/or alloying materials (e.g., Si), or oxides (e.g., Li₄Ti₅O₁₂) where lithium ions intercalate within graphite layers during the charge cycle, providing energy storage. LIB cathode materials are commonly oxide compounds of nickel, cobalt, or manganese (“NCM”) or aluminum. NCM cathode materials are interesting because these materials have a high charge capacity (˜200 milliAmp hours/gram (mAh/g)) relative to other types of cathode materials. However, these materials can be expensive to prepare and may adversely affect the environment by virtue of the need to obtain and process expensive ores to provide the necessary precursors, during which toxic waste materials are produced.

Recently, LFP (LiFePO₄) has emerged as one of the most promising cathode materials for lithium-ion batteries (LIBs), eliminating the conflict metals such as nickel and cobalt used extensively in non-LFP LIBs (e.g., NMC chemistries). However, the main challenge of this material is in its cost/performance at large scale production, specifically, cost of the raw materials and fabrication process. LFP materials that perform well in a battery (i.e., approaching the theoretical capacity of 170 milliAmp hours/gram (mA/g) and minimal capacity loss for at least 500 or 1000 charging cycles) can be fabricated from a variety of precursors and using a variety of techniques. However, these techniques may produce wastewater and require expensive, energy intensive processing techniques.

On the other hand, low cost (and low-quality) LFP (herein “LC-LFP”) can be prepared economically from iron oxide (a mineral), but its performance is poor. Poor performance of some types of LFP may be from uneven or poor-quality carbon coverage of the particles (thereby increasing the internal electrical resistance of the material) and/or from crystallographic defects that inhibit lithium-ion mobility. Both electron and ion transfer resistances are positively correlated to the particle size. Therefore, optimizing LFP electrode performance, particularly for use in lithium-ion batteries (LIB) includes reducing LFP particle sizes to less than 1 micron.

Optimizing LFP electrode performance may also include reducing crystal defects via annealing. However, the techniques of reducing particle size and high temperature treatments are incompatible due to unwanted crystal growth in the (desirably) small particles of LFP when processed at high temperatures. Unwanted crystal growth leads to electronically isolated zones and poorly accessible lithium (Li) ions in the cathode particle which reduce charging capacity. Therefore, targeting high-performance LFP electrodes suitable for LIB work requires implementation of conductive surface coating and particle-level engineering using advanced polymers and carbon technology.

The present disclosure therefore seeks to meet the need in the art for high-performance LFP materials produced from low-cost starting materials while overcoming the above drawbacks in previous materials and methods.

### SUMMARY

The present technology is generally directed to conglomerate particles comprising a porous carbon matrix particle and a plurality of cathode material particles, as well as methods for preparing cathode materials within a conductive carbon matrix. The methods generally comprise providing a slurry of cathode material particles in a solution of organogel precursor materials suitable for subsequent gelation to form organogels (e.g., polyimide or polyamic acid gels), allowing the organogel precursor materials to undergo gelation, thereby forming an organic matrix in the form of a wet organogel, and drying the wet organogel. The dry organogel (aerogel, xerogel, or aerogel-like) is subsequently pyrolyzed to form a porous carbon matrix material doped with particles of the cathode materials.

Various solid and solution phase methods of forming lithium iron phosphate materials have been previously reported. See, for example, U.S. Patent Application Publication Nos. 2011/0110838 to Wang et al., 2008/0099720 to Huang et al., 2010/0065787, and 2011/0091772 to Mishima et al.; U.S. Pat. No. 7,988,879 to Park et al. and U.S. Pat. No. 7,060,238 to Saidi et al.; European Patent Application Publication No. 1,921,698 to Dong; and International Patent Application Publication No. WO2004/092065 to Barker et al.

LFP alone has poor electrical conductivity and it is known in the art to provide added carbon (i.e., LFP/C) to yield the required conductivity. While previously reported methods provide, e.g., LFP cathode materials comprising carbon, this carbon is typically added using either carbon particles (e.g., carbon black) or by pyrolysis of a mixture of LFP precursors and sugar molecules. Neither of these prior methods of introducing carbon to the cathode material provide a conductive matrix comparable to that provided according to the methods disclosed herein.

The disclosed products and methods may use LFP from any source as a starting material, including low cost/quality LFP (LC-LFP) material, making the disclosed products and methods cost-effective. Further, the products and methods disclosed herein also overcome the poor performance of such materials by providing a porous carbon matrix in which LFP particles are at least partially embedded, thereby providing the carbon that is necessary for enhanced conductivity. The amount of carbon present in the final materials can be tuned to the minimum amount required for conductivity, thereby maximizing the amount of LFP, which is the component which stores charge in a final battery.

Production of the disclosed carbon matrix via pyrolysis occurs herein at a temperature high enough to pyrolyze the polymer of the organogel (e.g., polyamic acid, polyimide, or a combination thereof) to carbon, while at the same time preventing unwanted crystal growth in the LFP particles. Without wishing to be bound by theory, it is believed that the at least partial embedding of the LFP particles within pores of the carbon matrix particle prevents this possible crystal growth, which would otherwise result in reduced charging capacity in the battery cell.

Further, the methods disclosed herein generally utilize environmentally friendly chemistry, and where non-aqueous solvents are used, the solvents may be recycled, contributing to the overall low environmental impact of the methods.

In one aspect is provided a conglomerate particle comprising: a matrix particle comprising porous carbon; and a plurality of cathode material particles at least partially embedded within the matrix particle.

In some aspects, the plurality of cathode material particles comprises lithium metal phosphate (LMP) particles.

In some aspects, the metal (M) of the LMP is selected from the group consisting of Fe, Mn, V, and a combination of Fe and Mn.

In some aspects, the matrix particle has a particle size of from 100 nm to 20 microns, or from 1-10 microns.

In some aspects, at least some of the cathode material particles of the plurality have an average particle size D50 of less than 250 nm, or less than 150 nm.

In some aspects, the matrix particle has a specific internal surface area corresponding to internal pores from 50 m²/gram to 150 m²/gram.

In some aspects, at least some of the specific internal surface area is configured to be accessible to an electrolyte.

In some aspects, the matrix particle comprises an aerogel or a xerogel.

In some aspects, the aerogel of xerogel is formed as a bead or beads or as a monolith.

In some aspects, the aerogel or xerogel is derived from an organogel comprising a polyimide, a polyamic acid, or a combination thereof.

In some aspects, the aerogel or xerogel is a carbonized organogel.

In some aspects, the matrix particle has a pore structure comprising a fibrillar morphology.

In some aspects, the fibrillar morphology comprises struts of carbonized material with a width in a range from about 2 to about 10 nm.

In some aspects, the matrix particle has a substantially uniform pore size distribution.

In some aspects, the matrix particle has a mean pore size from about 1 to about 50 nm, or from about 5 to about 25 nm.

In some aspects, the matrix particle comprises pores, and wherein at least a portion of said pores are configured to accommodate the cathode material particles.

In some aspects, a weight ratio of carbon in the matrix material to the cathode material is less than 30:70, less than 10:90, or less than 5:95.

In another aspect is provided a method of preparing a conglomerate particle comprising a porous carbon matrix particle with a plurality of cathode material particles at least partially embedded within the matrix particle, the method comprising:
(a) preparing an aqueous solution of a salt of a polyamic acid;
(b) mixing cathode material particles with the aqueous solution of the salt of the polyamic acid;
(c1) gelling the mixture of step (b) to form an organogel comprising dispersed cathode material particles, and drying the organogel of step (c1) to form a dried intermediate; or
(c2) drying the mixture of step (b) to form a dried intermediate; and
(d) carbonizing the dried intermediate to form the conglomerate particle.

In some aspects, preparing the aqueous solution of the salt of the polyamic acid comprises:
combining in water a water-soluble diamine, a water-soluble carbonate or bicarbonate salt, and a tetracarboxylic acid dianhydride; and
allowing the components to react, providing the solution of the salt of the polyamic acid.

In some aspects, the combining comprises:
dissolving a water-soluble diamine in water to form an aqueous diamine solution;
adding the water-soluble carbonate or bicarbonate salt to the aqueous diamine solution;
adding a tetracarboxylic acid dianhydride to the aqueous solution of the diamine and the water-soluble carbonate or bicarbonate salt to form a solution; and
stirring the solution for a period of time in a range from about 1 hour to about 4 days at a temperature in a range from about 4 to about 60° C.

In some aspects, the combining comprises:
dissolving a water-soluble diamine in water to form an aqueous diamine solution;
adding a tetracarboxylic acid dianhydride to the aqueous diamine solution to form a suspension;
stirring the suspension for a period of time in a range from about 1 hour to about 4 days at a temperature in a range from about 4 to about 60° C.;
adding the water-soluble carbonate or bicarbonate salt to the suspension; and
stirring the suspension for a period of time in a range from about 1 hour to about 4 days at a temperature in a range from about 4 to about 60° C. to provide the aqueous solution of the salt of the polyamic acid.

In some aspects, the combining comprises:
adding to water, simultaneously or in rapid succession, a water-soluble diamine, a tetracarboxylic acid dianhydride, and the water-soluble carbonate or bicarbonate salt; and
stirring the resulting mixture for a period of time in a range from about 1 hour to about 4 days at a temperature in a range from about 4 to about 60° C. to provide the aqueous solution of the polyamic acid salt.

In some aspects, the water-soluble carbonate or bicarbonate salt comprises lithium, sodium, potassium, ammonium, or guanidinium cations. In some aspects, the water-soluble carbonate or bicarbonate salt is selected from the group consisting of lithium carbonate, lithium bicarbonate, sodium carbonate, sodium bicarbonate, potassium carbonate, potassium bicarbonate, ammonium carbonate, ammonium bicarbonate, guanidinium carbonate, and combinations thereof.

In some aspects, the water-soluble carbonate or bicarbonate salt is a carbonate, and a molar ratio of the water-soluble carbonate salt to the diamine is from about 1 to about 1.4; or the water-soluble carbonate or bicarbonate salt is a bicarbonate, and a molar ratio of the water-soluble bicarbonate salt to the diamine is from about 2 to about 2.8.

In some aspects, a molar ratio of the tetracarboxylic acid dianhydride to the diamine is from about 0.9 to about 1.1.

In some aspects, the tetracarboxylic acid dianhydride is selected from the group consisting of biphthalic dianhydride (BPDA), benzophenone tetracarboxylic dianhydride (BTDA), oxydiphthalic dianhydride (ODPA), napthanyl tetracarboxylic dianhydride, perylene tetracarboxylic dianhydride, and pyromellitic dianhydride (PMDA).

In some aspects, the diamine is 1,3-phenylenediamine, 1,4-phenylenediamine, or a combination thereof. In some aspects, the diamine is 1,4-phenylenediamine.

In some aspects, a range of concentration of the polyamic acid salt in the aqueous solution is from about 0.01 to about 0.3 g/cm³, based on the weight of the polyamic acid.

In some aspects, drying the organogel or intermediate comprises:
optionally, washing or solvent exchanging the organogel or intermediate; and
subjecting the organogel or intermediate to elevated temperature conditions, lyophilizing the organogel or intermediate, or contacting the organogel or intermediate with supercritical fluid carbon dioxide.

In some aspects, the porous carbon matrix comprises an aerogel or xerogel.

In some aspects, the carbonizing takes place under an inert atmosphere at a temperature of at least about 650° C.

In some aspects, the cathode material particles comprise at least one lithium metal phosphate (LMP), wherein the metal (M) is selected from iron, manganese, vanadium, and a combination of iron and manganese.

In some aspects, the cathode material particles comprise or consist essentially of LiFePO₄.

In some aspects, the cathode material is milled prior to or during step (b).

In some aspects, the milling comprises milling using a roller mill, planetary ball mill or bead agitator mill optionally using at least one milling medium selected from alumina, zirconia, and stainless steel.

In some aspects, the milling comprises dispersing the cathode material in a liquid phase optionally selected from water, ethanol, isopropanol, ethylene glycol, acetone, or a mixture thereof; and wet milling the cathode material.

In some aspects, the milling comprises dispersing the cathode material in the aqueous solution of the salt of the polyamic acid; and wet milling the cathode material during step (b) to produce cathode material particles.

In some aspects, step (b) comprises mixing for a period of time and under conditions sufficient to disperse the cathode material in the aqueous solution.

In some aspects, the organogel comprises a polyimide, and the gelling in step (c1) comprises adding a gelation initiator to convert the polyamic acid to the polyimide. In some aspects, the gelation initiator is acetic anhydride.

In some aspects, gelling the mixture in step (c1) is performed in a mold to form a wet gel monolith.

In some aspects, the method further comprises breaking the wet gel monolith into a plurality of pieces before the drying.

In some aspects, the method further comprises (e) pulverizing the dried material of step (c1).

In some aspects, the pulverizing produces particles having a mean particle size D50 of less than about 50 microns.

In some aspects, step (c1) further comprises mixing the aqueous solution of the salt of the polyamic acid with a non-aqueous-miscible liquid to form an emulsion after adding the gelation initiator.

In some aspects, the gelation initiator is acetic anhydride.

In some aspects, mixing to form an emulsion is performed for a period of time from about 1 to about 30 minutes, or from about 4 to about 15 minutes.

In some aspects, the organogel comprises a polyamic acid, and the gelling in step (c1) comprises adding a gelation initiator to convert the salt of the polyamic acid to the polyamic acid organogel, and wherein the gelation initiator is an acid. In some aspects, the acid is a carboxylic acid. In some aspects, the carboxylic acid is acetic acid.

In some aspects, the method further comprises between steps (b) and (c1), mixing the mixture of step (b) with a non-aqueous-miscible liquid to form an emulsion.

In some aspects, the mixing is performed for up to about 10 minutes, or from about 1 to about 3 minutes.

In some aspects, the mixing is performed using a homogenizer. In some aspects, the homogenizer is operated at a speed of at least 1000 rpm, such as from about 1000 to about 9000 rpm.

In some aspects, the non-aqueous-miscible liquid is selected from the group consisting of mineral spirit, hexane, heptane, kerosene, octane, toluene, other hydrocarbons, and combinations thereof. In some aspects, the non-aqueous-miscible liquid is mineral spirits.

In some aspects, the non-aqueous-miscible liquid further comprises a surfactant dissolved therein. In some aspects, the surfactant is present at a concentration from about 1-2 wt. % with respect to the non-aqueous-miscible liquid.

In some aspects, the method further comprises separating beads of the organogel formed in step (c1) prior to drying. In some aspects, separating comprises decanting the non-aqueous-miscible liquid and optionally, recycling the non-aqueous-miscible liquid.

In some aspects, the beads have a mean size in a range from about 5 to about 30 microns.

In some aspects, the method further comprises washing the gel beads with water, a C1 to C4 alcohol, acetone, acetonitrile, ether, tetrahydrofuran, toluene, liquid carbon dioxide, or a combination thereof.

In some aspects, at least some of the cathode material particles of the plurality have an average particle size D50 of less than 250 nm, or less than 150 nm.

In some aspects, the drying step (c2) is spray drying.

In yet another aspect is provided a conglomerate particle comprising a porous carbon matrix particle with a plurality of cathode material particles at least partially embedded within the matrix particle, obtained by or obtainable by the method disclosed herein.

In some aspects, a weight ratio of carbon in the matrix material to cathode material is less than 30:70, less than 10:90, or less than 5:95.

In a yet further aspect is provided an electrode comprising a conglomerate particle as disclosed herein.

In a still further aspect is provided an energy storage device comprising a conglomerate particle as disclosed herein. In some aspects, the energy storage device is a Li-ion battery.

The disclosure includes, without limitations, the following aspects.

Aspect 1: A conglomerate particle comprising: a matrix particle comprising porous carbon; and a plurality of cathode material particles at least partially embedded within the matrix particle.

Aspect 2: The conglomerate particle of Aspect 1, wherein the plurality of cathode material particles comprises lithium metal phosphate (LMP) particles.

Aspect 3: The conglomerate particle of Aspect 1 or 2, wherein the metal (M) of the LMP is selected from the group consisting of Fe, Mn, V, and a combination of Fe and Mn.

Aspect 4: The conglomerate particle of any one of Aspects 1-3, wherein the matrix particle has a particle size of from 100 nm to 20 microns, or from 1-10 microns.

Aspect 5: The conglomerate particle of any one of Aspects 1-4, wherein at least some of the cathode material particles of the plurality have an average particle size D50 of less than 250 nm.

Aspect 6: The conglomerate particle of any one of Aspects 1-5, wherein at least some of the cathode material particles of the plurality have an average particle size D50 of less than 150 nm.

Aspect 7: The conglomerate particle of any one of Aspects 1-6, wherein the matrix particle has a specific internal surface area corresponding to internal pores from 50 m²/gram to 150 m²/gram.

Aspect 8: The conglomerate particle of any one of Aspects 1-7, wherein at least some of the specific internal surface area is configured to be accessible to an electrolyte.

Aspect 9: The conglomerate particle of any one of Aspects 1-8, wherein the matrix particle comprises an aerogel or a xerogel.

Aspect 10: The conglomerate particle of Aspect 9, wherein the aerogel of xerogel is formed as a bead or beads or as a monolith.

Aspect 11: The conglomerate particle of any one of Aspects 9-10, wherein the aerogel or xerogel is derived from an organogel comprising a polyimide, a polyamic acid, or a combination thereof.

Aspect 12: The conglomerate particle of any one of Aspects 9-11, wherein the aerogel or xerogel is a carbonized organogel.

Aspect 13: The conglomerate particle of any one of Aspects 1-12, wherein the matrix particle has a pore structure comprising a fibrillar morphology.

Aspect 14: The conglomerate particle of Aspect 13, wherein the fibrillar morphology comprises struts of carbonized material with a width in a range from about 2 to about 10 nm.

Aspect 15: The conglomerate particle of any one of Aspects 1-14, wherein the matrix particle has a substantially uniform pore size distribution.

Aspect 16: The conglomerate particle of any one of Aspects 1-15, wherein the matrix particle has a mean pore size from about 1 to about 50 nm, or from about 5 to about 25 nm.

Aspect 17: The conglomerate particle of any one of Aspects 1-16, wherein the matrix particle comprises pores, and wherein at least a portion of said pores are configured to accommodate the cathode material particles.

Aspect 18: The conglomerate particle of any one of Aspects 1-17, wherein a weight ratio of carbon in the matrix material to the cathode material is less than 30:70, less than 10:90, or less than 5:95.

Aspect 19: A method of preparing a conglomerate particle comprising a porous carbon matrix particle with a plurality of cathode material particles at least partially embedded within the matrix particle, the method comprising:
(a) preparing an aqueous solution of a salt of a polyamic acid;
(b) mixing cathode material particles with the aqueous solution of the salt of the polyamic acid;
(c1) gelling the mixture of step (b) to form an organogel comprising dispersed cathode material particles, and drying the organogel of step (c1) to form a dried intermediate; or
(c2) drying the mixture of step (b) to form a dried intermediate; and
(d) carbonizing the dried intermediate to form the conglomerate particle.

Aspect 20: The method of Aspect 19, wherein preparing the aqueous solution of the salt of the polyamic acid comprises:
combining in water a water-soluble diamine, a water-soluble carbonate or bicarbonate salt, and a tetracarboxylic acid dianhydride; and
allowing the components to react, providing the solution of the salt of the polyamic acid.

Aspect 21: The method of Aspect 20, wherein the combining comprises:
dissolving a water-soluble diamine in water to form an aqueous diamine solution;
adding the water-soluble carbonate or bicarbonate salt to the aqueous diamine solution;
adding a tetracarboxylic acid dianhydride to the aqueous solution of the diamine and the water-soluble carbonate or bicarbonate salt to form a solution; and
stirring the solution for a period of time in a range from about 1 hour to about 4 days at a temperature in a range from about 4 to about 60° C.

Aspect 22: The method of Aspect 20, wherein the combining comprises:
dissolving a water-soluble diamine in water to form an aqueous diamine solution;
adding a tetracarboxylic acid dianhydride to the aqueous diamine solution to form a suspension;
stirring the suspension for a period of time in a range from about 1 hour to about 4 days at a temperature in a range from about 4 to about 60° C.;
adding the water-soluble carbonate or bicarbonate salt to the suspension; and
stirring the suspension for a period of time in a range from about 1 hour to about 4 days at a temperature in a range from about 4 to about 60° C. to provide the aqueous solution of the salt of the polyamic acid.

Aspect 23: The method of Aspect 20, wherein the combining comprises:
adding to water, simultaneously or in rapid succession, a water-soluble diamine, a tetracarboxylic acid dianhydride, and the water-soluble carbonate or bicarbonate salt; and
stirring the resulting mixture for a period of time in a range from about 1 hour to about 4 days at a temperature in a range from about 4 to about 60° C. to provide the aqueous solution of the polyamic acid salt.

Aspect 24: The method of any one of Aspects 19-23, wherein the water-soluble carbonate or bicarbonate salt comprises lithium, sodium, potassium, ammonium, or guanidinium cations.

Aspect 25: The method of any one of Aspects 19-24, wherein the water-soluble carbonate or bicarbonate salt is selected from the group consisting of lithium carbonate, lithium bicarbonate, sodium carbonate, sodium bicarbonate, potassium carbonate, potassium bicarbonate, ammonium carbonate, ammonium bicarbonate, guanidinium carbonate, and combinations thereof.

Aspect 26: The method of any one of Aspects 19-25, wherein the water-soluble carbonate or bicarbonate salt is a carbonate, and a molar ratio of the water-soluble carbonate salt to the diamine is from about 1 to about 1.4; or the water-soluble carbonate or bicarbonate salt is a bicarbonate, and a molar ratio of the water-soluble bicarbonate salt to the diamine is from about 2 to about 2.8.

Aspect 27: The method of any one of Aspects 19-26, wherein a molar ratio of the tetracarboxylic acid dianhydride to the diamine is from about 0.9 to about 1.1.

Aspect 28: The method of any one of Aspects 19-27, wherein the tetracarboxylic acid dianhydride is selected from the group consisting of biphthalic dianhydride (BPDA), benzophenone tetracarboxylic dianhydride (BTDA), oxydiphthalic dianhydride (ODPA), napthanyl tetracarboxylic dianhydride, perylene tetracarboxylic dianhydride, and pyromellitic dianhydride (PMDA).

Aspect 29: The method of any one of Aspects 19-28, wherein the diamine is 1,3-phenylenediamine, 1,4-phenylenediamine, or a combination thereof.

Aspect 30: The method of any one of Aspects 19-29, wherein the diamine is 1,4-phenylenediamine.

Aspect 31: The method of any one of Aspects 19-30, wherein a range of concentration of the polyamic acid salt in the aqueous solution is from about 0.01 to about 0.3 g/cm³, based on the weight of the polyamic acid.

Aspect 32: The method of any one of Aspects 19-31, wherein drying the organogel or intermediate comprises:
optionally, washing or solvent exchanging the organogel or intermediate; and
subjecting the organogel or intermediate to elevated temperature conditions, lyophilizing the organogel or intermediate, or contacting the organogel or intermediate with supercritical fluid carbon dioxide.

Aspect 33: The method of any one of Aspects 19-32, wherein the porous carbon matrix comprises an aerogel or xerogel.

Aspect 34: The method of any one of Aspects 19-33, wherein the carbonizing takes place under an inert atmosphere at a temperature of at least about 650° C.

Aspect 35: The method of any one of Aspects 19-34, wherein the cathode material particles comprise at least one lithium metal phosphate (LMP), wherein the metal (M) is selected from iron, manganese, vanadium, and a combination of iron and manganese.

Aspect 36: The method of any one of Aspects 19-35, wherein the cathode material particles comprise or consist essentially of LiFePO₄.

Aspect 37: The method of any one of Aspects 19-36, wherein the cathode material is milled prior to or during step (b).

Aspect 38: The method of Aspect 37, wherein the milling comprises milling using a roller mill, planetary ball mill or bead agitator mill optionally using at least one milling medium selected from alumina, zirconia, and stainless steel.

Aspect 39: The method of Aspect 37 or 38, wherein the milling comprises dispersing the cathode material in a liquid phase optionally selected from water, ethanol, isopropanol, ethylene glycol, acetone, or a mixture thereof; and wet milling the cathode material.

Aspect 40: The method of any one of Aspects 37-39, wherein the milling comprises dispersing the cathode material in the aqueous solution of the salt of the polyamic acid; and wet milling the cathode material during step (b) to produce cathode material particles.

Aspect 41: The method of any one of Aspects 19-40, wherein step (b) comprises mixing for a period of time and under conditions sufficient to disperse the cathode material in the aqueous solution.

Aspect 42: The method of any one of Aspects 19-41, wherein the organogel comprises a polyimide, and the gelling in step (c1) comprises adding a gelation initiator to convert the polyamic acid to the polyimide.

Aspect 43: The method of Aspect 42, wherein the gelation initiator is acetic anhydride.

Aspect 44: The method of any one of Aspects 19-43, wherein gelling the mixture in step (c1) is performed in a mold to form a wet gel monolith.

Aspect 45: The method of Aspect 44, further comprising breaking the wet gel monolith into a plurality of pieces before the drying.

Aspect 46: The method of any one of Aspects 19-45, further comprising (e) pulverizing the dried material of step (c1).

Aspect 47: The method of Aspect 46, wherein the pulverizing produces particles having a mean particle size D50 of less than about 50 microns.

Aspect 48: The method of any one of Aspects 19-43, wherein step (c1) further comprises mixing the aqueous solution of the salt of the polyamic acid with a non-aqueous-miscible liquid to form an emulsion after adding the gelation initiator.

Aspect 49: The method of Aspect 48, wherein the gelation initiator is acetic anhydride.

Aspect 50: The method of any one of Aspects 48-49, wherein mixing to form an emulsion is performed for a period of time from about 1 to about 30 minutes, or from about 4 to about 15 minutes.

Aspect 51: The method of any one of Aspects 19-41, wherein the organogel comprises a polyamic acid, and the gelling in step (c1) comprises adding a gelation initiator to convert the salt of the polyamic acid to the polyamic acid organogel, and wherein the gelation initiator is an acid.

Aspect 52: The method of Aspect 51, wherein the acid is a carboxylic acid.

Aspect 53: The method of Aspect 52, wherein the carboxylic acid is acetic acid.

Aspect 54: The method of any one of Aspects 51-53, further comprising between steps (b) and (c1), mixing the mixture of step (b) with a non-aqueous-miscible liquid to form an emulsion.

Aspect 55: The method of Aspect 54, wherein the mixing is performed for up to about 10 minutes, or from about 1 to about 3 minutes.

Aspect 56: The method of Aspect 54 or 55, wherein the mixing is performed using a homogenizer.

Aspect 57: The method of Aspect 56, wherein the homogenizer is operated at a speed of at least 1000 rpm, such as from about 1000 to about 9000 rpm.

Aspect 58: The method of any one of Aspects 48-50 or 54-57, wherein the non-aqueous-miscible liquid is selected from the group consisting of mineral spirit, hexane, heptane, kerosene, octane, toluene, other hydrocarbons, and combinations thereof.

Aspect 59: The method of Aspect 58, wherein the non-aqueous-miscible liquid is mineral spirits.

Aspect 60: The method of any one of Aspects 48-50 or 54-59, wherein the non-aqueous-miscible liquid further comprises a surfactant dissolved therein.

Aspect 61: The method of Aspect 60, wherein the surfactant is present at a concentration from about 1-2 wt. % with respect to the non-aqueous-miscible liquid.

Aspect 62: The method of any one of Aspects 48-61, further comprising separating beads of the organogel formed in step (c1) prior to drying.

Aspect 63: The method of Aspect 62, wherein separating comprises decanting the non-aqueous-miscible liquid and optionally, recycling the non-aqueous-miscible liquid.

Aspect 64: The method of Aspect 62 or 63, wherein the beads have a mean size in a range from about 5 to about 30 microns.

Aspect 65: The method of any one of Aspects 62 to 64, further comprising washing the gel beads with water, a C1 to C4 alcohol, acetone, acetonitrile, ether, tetrahydrofuran, toluene, liquid carbon dioxide, or a combination thereof.

Aspect 66: The method of any one of Aspects 19 to 65, wherein at least some of the cathode material particles of the plurality have an average particle size D50 of less than 250 nm, or less than 150 nm.

Aspect 67: The method of any one of Aspects 19-66, wherein the drying step (c2) is spray drying.

Aspect 68: A conglomerate particle comprising a porous carbon matrix particle with a plurality of cathode material particles at least partially embedded within the matrix particle, obtained by or obtainable by the method of any one of Aspects 19-67.

Aspect 69: The conglomerate particle of Aspect 68, wherein a weight ratio of carbon in the matrix material to cathode material is less than 30:70, less than 10:90, or less than 5:95.

Aspect 70: An electrode comprising a conglomerate particle according to any one of Aspects 1-18 or 68-69.

Aspect 70: An energy storage device comprising a conglomerate particle according to any one of Aspects 1-18 or 68-69.

Aspect 71: The energy storage device of Aspect 70, which is a Li-ion battery.

### BRIEF DESCRIPTION OF THE DRAWINGS

In order to provide an understanding of aspects of the technology, reference is made to the appended drawings, which are not necessarily drawn to scale. The aspects are illustrated by way of example and not by way of limitation in the accompanying drawings. It should be noted that references to “an” or “one” aspect in this disclosure are not necessarily to the same aspect, and they mean at least one.

FIG. 1 schematically illustrates a method 100 for producing conglomerate particles according to one or more non-limiting aspects of the present disclosure.

FIG. 2 schematically illustrates a further method 200 for producing conglomerate particles according to one or more non-limiting aspects of the present disclosure.

FIG. 3 schematically illustrates a yet further method 300 for producing conglomerate particles according to one or more non-limiting aspects of the present disclosure.

FIG. 4 schematically illustrates another method 400 for producing conglomerate particles according to one or more non-limiting aspects of the present disclosure.

FIG. 5A is a schematic illustration of a conglomerate particle according to one or more non-limiting aspects of the present disclosure.

FIG. 5B is a schematic illustration of a conglomerate particle according to one or more non-limiting aspects of the present disclosure.

FIG. 6 is a schematic illustration of a conglomerate particle 600 according to one or more non-limiting aspects of the present disclosure.

FIG. 7 is a schematic illustration of a conglomerate particle according to one or more non-limiting aspects of the present disclosure.

FIGS. 8A, 8B, 8C, and 8D are scanning electron micrographs of conglomerate particles according to one or more non-limiting aspects of the present disclosure.

FIG. 9 is a first cycle charge-discharge voltage profile including conglomerate particles according to one or more non-limiting aspects of the present disclosure.

FIG. 10 is a chart illustrating rate performance including conglomerate particles according to one or more non-limiting aspects of the present disclosure.

FIG. 11 is a chart illustrating capacity loss including conglomerate particles according to one or more non-limiting aspects of the present disclosure.

### DETAILED DESCRIPTION

In the following description, for the purposes of explanation, numerous specific details are set forth to provide a thorough understanding. One or more aspects may be practiced without these specific details. Features described in one aspect may be combined with features described in a different aspect. In some examples, well-known structures and devices are described with reference to a block diagram form to avoid unnecessarily obscuring the present invention.

### I. General Overview

The present disclosure describes an LMP-carbon composite in which nanoscale particles of LMP are at least partially embedded in a porous carbon particle or bead having a mean particle size of from 0.5 to 20 micron. Herein “LMP” means “lithium metal phosphate” which includes LFP (“lithium iron phosphate, where the metal “M” is iron), LMFP (“lithium manganese-iron phosphate, where the metal “M” is a solid-solution of manganese and iron) and LVP (“lithium vanadium phosphate”, where the metal “M” is vanadium) and mixtures thereof, as herein described. This conglomerate particle configuration, with particles of LMP being physically separated from one another by virtue of being embedded in the carbon matrix, enables kinetically favorable access of electrolyte to the LMP, thereby supporting high charging and discharging rates without a significant loss of capacity.

In principle, LMP obtained through any synthetic approach can be pulverized and used for the fabrication of the disclosed LMP-doped carbon aerogel or xerogel composites. However, for cost and scalability optimization, LMP may be made through the lowest-cost implementation, which in one example is LFP synthesis through solid-state carbothermal reduction starting from ferric oxide (hematite), phosphoric acid, lithium carbonate, and a carbon source. Such as-prepared low cost (and low-quality LFP) (herein “LC-LFP”) has supra-micron particle sizes and extremely poor performance (e.g., ˜20 mAh/g compared to a theoretical specific capacity: 169.9 mAh/g) if used as a cathode in half-cells. Milling the aforementioned LC-LFP can increase the capacity to ˜80 mAh/g, which is still lower than half of the theoretical capacity. For example, if the same LFP is milled for a number of hours, the capacity increases to 78 mAh/g, which is significantly higher than the as-prepared LC-LFP and demonstrates the inhibiting effect of large particle size on cathode capacity. Despite the four-fold increase, this capacity is still too low to be used in many commercial applications, particularly transportation applications (e.g., electric vehicles).

According to the present disclosure, it was surprisingly found that the battery performance of LC-LFP can be greatly improved if it is embedded within a porous carbon matrix, such as carbon aerogels or xerogels, in various form factors including monolith and microbead. The disclosed LFP-carbon aerogel composite beads have shown an additional increase of the practical capacity of LFP by more than 50% compared to pulverized LFP alone, so that capacities exceeding 145 mAh/g become achievable when the same LFP in its pre-carbon conglomerate form may have capacities less than 100 mAh/g or even less than 70 mAh/g. A second unexpected benefit is that the conglomerate particle cathode demonstrates high-rate performance (80% capacity retention at 1C, compared to C/20). As a third advantage, the LFP-doped conglomerate particle cathode exhibits outstanding cycle-life, with no capacity loss after 500 cycles at 1C charge-discharge rate in half-cells comprised of metallic lithium anode.

Overall, the newly developed process to improve the performance of LC-LFP can be summarized by the following key characteristics and benefits: (1) high specific capacity LFP-carbon aerogel micro-composite beads are obtained from low-cost LC-LFP material; (2) high-rate performance is achieved compared to commercially available LFP; (3) excellent capacity retention is achieved even at high-rate cycling; (4) the carbon aerogel used in LFP/carbon aerogel material is cost effective and preparation thereof is environmentally friendly; and (5) new classes of LFP materials have been developed for diverse applications.

To produce the disclosed conglomerate particles, LFP produced from any source, including low-cost or bulk LC-LFP is mixed with a solution of a suitable salt of a polyamic acid to form a slurry. An advantage of the present method is that the viscosity of the polyamic acid salt solution is sufficient to keep the particles of LFP in suspension, leading to excellent dispersion of the LFP particles throughout the gels and final products that are formed. The LFP may be milled to reduce particle size before or after mixing with the aqueous solution and may further be processed into various forms such as a solid monolithic or microbead composite of LFP particles in a polymer matrix. In the microbead composite variation, microdroplets of the aqueous polyamate solution with the LFP suspension become the dispersed phase in a two-phase emulsion and are gelled with a suitable gelation initiator (e.g., an acid anhydride such as acetic anhydride, an acid such as acetic acid, or an acid precursor such as acetic anhydride) while in dispersion. The resulting gel microbeads are dried into LFP-doped polyimide or polyamic acid aerogel or xerogel beads, which may be carbonized into LFP-doped carbon aerogel or xerogel microbeads.

The preparation of monolithic LFP-doped carbon aerogel micro-composites follows as above, with the emulsification step replaced by introducing the wet suspension and the gelation initiator into molds to form a monolithic wet organogel. After drying the gel to form an aerogel or xerogel, the aerogel or xerogel may be broken up into powder form before pyrolyzing to form the conglomerate particle including a carbon matrix. Alternatively, the slurry is not gelled but is instead spray-dried to form a powder including LFP particles and polymer. This again may be pyrolyzed to form the carbon matrix. The conglomerate particles limit unwanted crystallite growth of the LFP during the carbonization/pyrolyzing step and provide high-performance cathodes with fast ionic and electronic transfer rates.

In a first general method of the present disclosure, a slurry of LMP (where M can be Fe, Mn/Fe, or V) and an aqueous solution of a polyamic acid salt is contacted with a gelation initiator (such as an anhydride) and the gelling solution emulsified with a non-aqueous-miscible liquid to yield beads of polyimide gel, which are separated, washed, and dried to form aerogel or xerogel beads doped with the LMP. In an alternative emulsion process described herein, the slurry is first emulsified to form liquid beads which are subsequently gelled using a gelation initiator (such as an acid or anhydride) to form wet gel polyamic acid and/or polyimide beads. Again, these beads are separated, washed, and dried. Thirdly, avoiding the emulsion step, the slurry may be gelled in a mold using a gelation initiator (such as an acid or anhydride) to form a monolithic wet organogel (polyamic acid and/or polyimide). This monolith can be broken to particles then dried to form an aerogel or xerogel.

In order to prepare LFP-doped carbon aerogel micro-composite beads as described herein, commercially purchased, low-cost (and also low performance) LC-LFP was ball-milled and was incorporated in polyimide or polyamic acid microspheres using an emulsion gelation process. Drying the microspheres yielded low-cost LFP-doped polyimide or polyamic acid xerogels or aerogels which were carbonized/annealed into LFP-doped carbon aerogels or xerogels.

One or more aspects described in this Specification and/or recited in the claims may not be included in this General Overview section.

### II. Definitions

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article. The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, in some examples, the terms “framework” or “framework structure” refer to the network of nanoscopic and/or microscopic structural elements, such as fibrils, struts, and/or colloidal particles that form the solid structure of a gel or an aerogel. The structural elements that make up the framework structures have at least one characteristic dimension (e.g., length, width, diameter) of about 100 angstroms or less. In examples of pyrolyzed or carbonized aerogels, the terms “framework” or “framework structure” may refer to an interconnected network of linear fibrils, nanoparticles, a bicontinuous network (e.g., networks transitioning between a fibrillar and spherical morphology with aspects of both transitional structures), or combinations thereof. In some examples, the linear fibrils, nanoparticles, or other structural elements may be connected together (at nodes in some examples) to form a framework that defines pores.

As used herein, the terms “aerogel” and “aerogel material” refer to a solid object, irrespective of shape or size, comprising a framework of interconnected solid structures, with a corresponding network of interconnected pores integrated within the framework, and containing gases such as air as a dispersed interstitial medium. As such, and irrespective of the drying method used, aerogels are open non-fluid colloidal or polymer networks that are expanded throughout their whole volume by a gas, and are formed by the removal of all swelling agents (e.g., solvents) from a corresponding wet gel without substantial volume reduction or network compaction.

Generally, aerogels possess one or more of the following physical and structural properties: (a) an average pore diameter ranging from about 2 nm to about 100 nm; (b) a porosity of about 60% or more; (c) a specific surface area of about 1, about 10, or about 20, to about 100 or about 1000 m²/g. Typically, such properties are determined using nitrogen sorption porosimetry testing and/or helium pycnometry. It can be understood that the inclusion of additives, such as a reinforcement material or an electrochemically active species, for example, silicon or lithium iron phosphate may decrease porosity and the specific surface area of the resulting aerogel composite. Densification may also decrease porosity of the resulting aerogel composite.

Aerogel materials may also be further characterized by additional physical properties, including: (d) a pore volume of about 2.0 mL/g or more, preferably about 3.0 mL/g or more; (e) a density of about 0.50 g/cc or less, preferably about 0.25 g/cc or less; and (f) at least 50% of the total pore volume comprising pores having a pore diameter of between 2 and 50 nm; though satisfaction of these additional properties is not required for the characterization of a compound as an aerogel material. Reference to an “aerogel” herein includes any aerogels or other open-celled materials porous materials which can be characterized as aerogels, xerogels, cryogels, ambigels, microporous materials, and the like, regardless of material (e.g., polyimide, polyamic acid, or carbon), unless otherwise stated.

In some aspects, a gel material may be referred to specifically as a xerogel. As used herein, the term “xerogel” refers to a type of aerogel comprising an open, non-fluid colloidal or polymer network that is formed by the removal of all swelling agents from a corresponding wet gel without any precautions taken to avoid substantial volume reduction or to retard compaction. A xerogel generally comprises a compact structure. Xerogels suffer substantial volume reduction during ambient pressure drying and generally have a porosity of about 40% or less.

The terms “carbon aerogel” or “carbon xerogel” as used herein refer to porous, carbon-based materials. Some non-limiting examples of carbon aerogels and xerogels include carbonized aerogels and xerogels such as carbonized polyimide gels. The term “carbonized” in the context of aerogels and xerogels refers to an organic gel (e.g., a polyimide) which has been subjected to pyrolysis in order to decompose or transform the organogel composition to at least substantially pure carbon. As used herein, the terms “pyrolyze” or “pyrolysis” or “carbonization” refer to the decomposition or transformation of an organic matrix to pure or substantially pure carbon caused by heat.

Monolithic aerogel materials are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (i.e., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically involves preparation of a paste or slurry from the powder, casting and drying onto a substrate, and may optionally include calendaring.

Within the context of the present disclosure, the terms “binder-less” or “binder-free” (or derivatives thereof) refer to a material being substantially free of binders or adhesives to hold that material together. For example, a monolithic nanoporous carbon material is free of binder since its framework is formed as a unitary, continuous interconnected structure. Advantages of being binder-less include avoiding any effects of binders, such as on electrical conductivity and pore volume. On the other hand, aerogel particles require a binder to hold together to form a larger, functional material; such larger material is not contemplated herein to be a monolith. In addition, this “binder-free” terminology does not exclude all uses of binders. For example, a monolithic aerogel, according to the present disclosure, may be secured to another monolithic aerogel or a non-aerogel material by disposing a binder or adhesive onto a major surface of the aerogel material. In this way, the binder is used to create a laminate composite and provide electrical contact to a current collector, but the binder has no function to maintain the stability of the monolithic aerogel framework itself.

As used herein, the term “gelation” or “gel transition” refers to the formation of a wet gel from a polymer system, e.g., a polyimide, or polyamic acid as described herein. At a point during the reactions or processes described herein with respect to gelation, defined as the “gel point,” the sol loses fluidity. In the present context, gelation proceeds from an initial sol state (e.g., a solution of a salt of a polyamic acid), through a highly viscous disperse state, until the disperse state solidifies and the sol gels (the gel point), yielding a wet gel (e.g., polyimide or polyamic acid gel). Notably, such definition of gelation and gel point is simplified and does not take into account the potential for fluidity under stress, such as the thixotropic behavior of certain gels. In some aspects, gelation is induced by addition of a suitable gelation initiator. In other aspects, gelation may be induced by removal of solvent, e.g., from a solution comprising a salt of a polyamic acid. As described herein, such solvent removal can be accomplished by various drying techniques including, but not limited to, spray drying.

As used herein, the term “wet gel” refers to a gel in which the mobile interstitial phase within the network of interconnected pores is primarily comprised of a liquid phase such as a conventional solvent or water, liquefied gases such as liquid carbon dioxide, or a combination thereof. Aerogels typically require the initial production of a wet gel, followed by processing and extraction to replace the mobile interstitial liquid phase in the gel with air or another gas. Examples of wet gels include, but are not limited to: alcogels, hydrogels, ketogels, carbonogels, and any other wet gels known to those in the art.

As used herein, the term “mean/average particle size” is synonymous with D50, meaning half of the population of particles has a particle size above this point, and half below. Particle size may be measured by laser light scattering techniques or by microscopic techniques. Unless otherwise indicated, average particle sizes reported herein are obtained by visual interpretation of SEM images using the calibration scale bar and image processing software (such as ImageJ). Multiple particles are measured randomly, the results are averaged, and standard deviations are calculated. For secondary particles and aggregates, laser diffraction particle size analysis is used.

As used herein, the term “positive electrode” is used interchangeably with cathode. Likewise, the term “negative electrode” is used interchangeably with anode.

Within the context of the present disclosure, the term “electrical conductivity” refers to a measurement of the ability of a material to conduct an electric current or other allow the flow of electrons therethrough or therein. Electrical conductivity is specifically measured as the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84—resistivity (R) measurements obtained by measuring voltage (V) divided by current (I), unless otherwise stated. In certain aspects, materials of the present disclosure have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

Within the context of the present disclosure, the term “capacity” refers to the amount of specific energy or charge that a battery is able to store. Capacity is specifically measured as the discharge current that the battery can deliver over time, per unit mass. It is typically recorded as Ampere-hours or milliAmpere-hours per gram of total electrode mass, Ah/g or mAh/g. For example, a battery with 1 Ah capacity can supply a current of one ampere for one hour or 0.5 amps for two hours, etc. Therefore, 1 Ampere-hour (Ah) is the equivalent of 3,600 coulombs of electrical charge. Similarly, the term “milliampere-hour (mAh)” also refers to a unit of the storage capacity of a battery and is 1/1,000 of an Ampere-hour. The capacity of a battery (and a cathode in particular) may be determined by methods known in the art, for example including, but not limited to: applying a fixed constant current load to a fully charged cell until the cell's voltage reaches the end of discharge voltage value; the time to reach end of discharge voltage multiplied by the constant current is the discharge capacity; by dividing the discharge capacity by the weight of electrode material or volume. Within the context of the present disclosure, measurements of capacity are acquired according to this method, unless otherwise stated. Unless otherwise noted, capacity is reported at cycle 10 of the battery.

As used herein, the term “battery cycle life” refers to the number of complete charge/discharge cycles a battery can perform before its nominal capacity falls below 80% of its initial rated capacity. Cycle life may be affected by a variety of factors that are not significantly impacted over time, for example mechanical strength of the underlying substrate, connectivity of particles within the cathode material, and maintenance of interconnectivity of the carbon matrix. It is noted that these factors actually remaining relatively unchanged over time is a surprising aspect of certain aspects of the current invention. Cycle life may be determined by methods known in the art, for example including, but not limited to, cycle testing, where battery cells are subject to repeated charge/discharge cycles at predetermined current rates and operating voltage. Within the context of the present disclosure, measurements of cycle life are acquired according to this method, unless otherwise stated. In certain aspects of the present disclosure, energy storage devices, such as batteries, or electrode thereof, have a cycle life of about 25 cycles or more, 50 cycles or more, 75 cycles or more, 100 cycles or more, 200 cycles or more, 300 cycles or more, 500 cycles or more, 1000 cycles or more, or in a range between any two of these values.

The term “substantially” as used herein, unless otherwise indicated, means to a great extent, for example, greater than about 95%, greater than about 99%, greater than about 99.9%, greater than 99.99%, or even 100% of a referenced characteristic, quantity, etc. as pertains to the particular context (e.g., substantially pure, substantially the same, and the like.

While the present specification may refer to “LFP”, the teaching herein is applicable to cathode materials more generally and in particular lithium metal phosphates (LMP) where the metal may be selected from iron (i.e., LFP, LiFePO₄), vanadium, manganese, or combinations of iron and manganese. The LMPs discussed herein may comprise, consist of or consist essentially of a single lithium metal phosphate (e.g., LFP), or a mixture thereof (e.g., particles of LFP and LVP, where V=vanadium). Alternatively, or in combination, the LFP materials described herein may be continuous solid solutions containing a mixture of transitions metals, such as LiFe₁₋ₓMnₓPO₄ (where 0≤x≤1). The term “LFP” is not to be construed as limited to iron-containing LFPs only and is used interchangeably with “LMP”+carbon coating.

### III. Aerogel Synthesis

As indicated above in the General Overview, the present disclosure is directed to LMP-carbon composite particles and their synthesis. These materials, useful for lithium-ion battery cathode materials, are equivalently referred to herein as “conglomerate particles” or conglomerate or composite microbeads. The composite particles may be formed by synthesizing or acquiring pre-synthesized (e.g., via commercial channels) LMP particles and combining the LMP particles with organogel precursors.

The methods disclosed herein generally utilize polyamic acid and polyimide wet gels, which may be prepared without the use of organic solvents, and without use of organic (e.g., amine) bases. Reference herein to preparation of polyamic acid and polyimide wet gels “without the use of organic bases” means that carbon-based alkaline materials such as amines are not utilized for the solubilization in water of a preformed polyamic acid nor for the in situ solubilization of polyamic acid as it is formed (i.e., by reaction between a diamine and tetracarboxylic dianhydride). For the avoidance of doubt, reference to an “organic base” does not include carbonate and bicarbonate salts, and further does not include carbonate and bicarbonate salts which comprise a nitrogen-containing cationic species (such as ammonium or guanidinium).

Reference herein to an aqueous solution means that the solution is substantially free of any organic solvent. The term “substantially free” as used herein in the context of organic solvents means that no organic solvent has been intentionally added, and no organic solvent is present beyond trace amounts. For example, in certain aspects, the aqueous solution can be characterized as having less than 1% by volume of organic solvent, or less than 0.1%, or less than 0.01%, or even 0% by volume of organic solvent. These water-based methods are advantageous in reducing material and waste disposal costs, and reducing potential safety and environmental hazards.

### A. Preparing Polyamic Acid and Polyimide Gels and Aerogel Materials Under Aqueous Conditions

Utilized herein are methods of preparing polyamic acid and polyimide gel materials under aqueous conditions. The methods generally comprise preparing an aqueous solution of a polyamic acid salt without the use of organic bases, and subsequently converting the polyamic acid salt to a polyamic acid gel or aerogel material, a polyimide gel or aerogel material, or a corresponding carbon aerogel material. Each of these materials and the corresponding method(s) are described further herein below.

In one aspect, the method comprises providing a polyamic acid and combining in water the polyamic acid and a water-soluble carbonate or bicarbonate salt, thereby providing the solution of the salt of the polyamic acid. In such aspects, the polyamic acid is a preformed polyamic acid, either a purchased, commercially available material or a material prepared from a suitable diamine and tetracarboxylic anhydride according to conventional, known techniques (such as preparation in an organic solvent solution). Suitable preformed polyamic acids are as described herein below with respect to in situ synthesized polyamic acids. Suitable water-soluble carbonate or bicarbonate salts are described further herein below.

Alternatively, the polyamic acid may be prepared in situ. Accordingly, in another aspect the aqueous solution of the polyamic acid salt is prepared by reaction of a water-soluble diamine and a tetracarboxylic acid dianhydride in the presence of a water-soluble carbonate or bicarbonate salt. Generally, the diamine is allowed to react with the tetracarboxylic acid dianhydride in the presence of the said carbonate or bicarbonate salt to form the polyamic acid salt. Accordingly, the method comprises combining in water a water-soluble diamine, a water-soluble carbonate or bicarbonate salt, and a tetracarboxylic acid dianhydride; and allowing the components to react, providing the solution of the polyamic acid salt. The polyamic acid salt comprises anionic carboxylate groups which are charge compensated by the cations from the carbonate or bicarbonate salt, and the polyamic acid salt is soluble in water. Each of the components utilized in the method (e.g., water-soluble diamine, tetracarboxylic acid dianhydride, water-soluble carbonate or bicarbonate salt and the like) are described further herein below.

The order of addition of the various components may vary. For example, in some aspects, combining comprises dissolving a water-soluble diamine in water to form an aqueous diamine solution; adding the water-soluble carbonate or bicarbonate salt to the aqueous diamine solution; adding the tetracarboxylic acid dianhydride to the aqueous solution of the diamine and the water-soluble carbonate or bicarbonate salt to form a solution; and stirring the solution for a period of time in a range from about 1 hour to about 4 days at a temperature in a range from about 15 to about 60° C.

In some aspects, combining comprises dissolving the water-soluble diamine in water to form an aqueous diamine solution; adding the tetracarboxylic acid dianhydride to the aqueous diamine solution to form a suspension; stirring the suspension for a period of time in a range from about 1 minute to about 24 hours at a temperature in a range from about 15 to about 60° C.; adding a water-soluble salt carbonate or bicarbonate salt to the suspension; and stirring the suspension for a period of time in a range from about 1 hour to about 4 days at a temperature in a range from about 15 to about 60° C. to provide the aqueous solution of the polyamic acid salt.

In some aspects, combining comprises adding to water, simultaneously or in rapid succession, a water-soluble diamine, a tetracarboxylic acid dianhydride, and a water-soluble carbonate or bicarbonate salt; and stirring the resulting mixture for a period of time in a range from about 1 hour to about 4 days at a temperature in a range from about 15 to about 60° C. to provide the aqueous solution of the polyamic acid salt.

A non-limiting, generic reaction sequence is provided in Scheme 1. In some, the reactions occur generally according to Scheme 1, and the reagents and product have structures according to the formulae in Scheme 1.

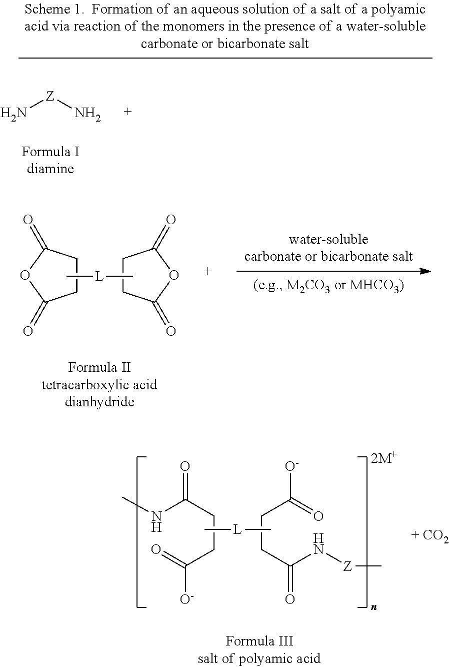

The diamine as disclosed herein is generally described as a “water-soluble diamine.” As used herein, the term “water-soluble diamine” means that the diamine has appreciable solubility in water, such that synthetically useful concentrations of the diamine can be obtained under the conditions utilized in the disclosed method. For example, diamines suitable for use in the disclosed methods may have a solubility in water at 20° C. of at least about 0.01 g per 100 mL, at least about 0.1 g per 100 mL, at least about 1 g per 100 mL, or at least about 10 g per 100 mL.

In some aspects, combinations of more than one diamine may be used. Combinations of diamines may be used in order to optimize the properties of the gel material. In some aspects, a single diamine is used.

With reference to Scheme I, the structure of the diamine may vary. In some aspects, the diamine has a structure according to Formula I, where Z is aliphatic (i.e., alkylene, alkenylene, alkynylene, or cycloalkylene) or aryl, each as described herein above. In some aspects, Z is alkylene, such as C2 to C12 alkylene or C2 to C6 alkylene. In some aspects, the diamine is a C2 to C6 alkane diamine, such as, but not limited to, 1,3-diaminopropane, 1,4-diaminobutane, 1,5-diaminopentane, 1,6-diaminohexane, and ethylenediamine. In some aspects, the C2 to C6 alkylene of the alkane diamine is substituted with one or more alkyl groups, such as methyl.

In some aspects, Z is aryl. In some aspects, the aryl diamine is 1,3-phenylenediamine, methylene dianiline, 1,4-phenylenediamine (PDA), or a combination thereof. In some aspects, the diamine is 1,3-phenylenediamine. In some aspects, the diamine is 1,4-phenylenediamine (PDA).

With continued reference to Scheme 1, a tetracarboxylic acid dianhydride is added. In some aspects, more than one tetracarboxylic acid dianhydride is added. Combinations of tetracarboxylic acid dianhydrides may be used in order to optimize the properties of the gel material. In some aspects, a single tetracarboxylic acid dianhydride is added. The structure of the tetracarboxylic acid dianhydride may vary. In some aspects, the tetracarboxylic acid dianhydride has a structure according to Formula II, where L comprises an alkylene group, a cycloalkylene group, an arylene group, or a combination thereof, each as described herein above. In some aspects, L comprises an arylene group. In some aspects, L comprises a phenyl group, a biphenyl group, or a diphenyl ether group. In some aspects, the tetracarboxylic acid dianhydride of Formula II has a structure selected from one or more structures as provided in Table 1.

TABLE 1
Non-limiting list of potential tetracarboxylic acid dianhydrides

| Structure | IUPAC Name | Common/Alternative Name |
|---|---|---|
| 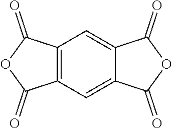 [SMILES: O=c1oc(=O)c2cc3c(=O)oc(=O)c3cc12] | 1H,3H-benzo[1,2-c:4,5-c′]difuran- 1,3,5,7-tetraone | pyromellitic anhydride (PMDA) |
| 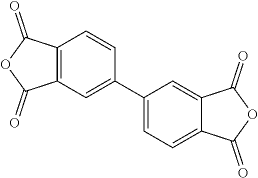 [SMILES: O=C1OC(=O)c2cc(-c3ccc4c(c3)C(=O)OC4=O)ccc21] | [5,5′-biisobenzofuran]- 1,1′,3,3′- tetraone | 3,3′,4,4′- bisphenyltetracarboxylic dianhydride; biphthalic dianhydride (BPDA) |
| 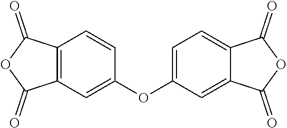 [SMILES: O=C1OC(=O)c2cc(Oc3ccc4c(c3)C(=O)OC4=O)ccc21] | 5,5′-oxybis(isobenzofuran-1,3- dione) | 4,4′-oxydiphthalic dianhydride (ODPA) |
| 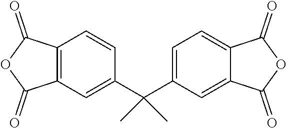 [SMILES: CC(C)(c1ccc2c(c1)C(=O)OC2=O)c1ccc2c(c1)C(=O)OC2=O] | 5,5′-(propane-2,2- diyl)bis(isobenzofuran-1,3-dione) | 4,4′- (isopropylidene)diphathalic dianhydride |
| 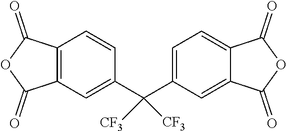 [SMILES: O=C1OC(=O)c2cc(C(c3ccc4c(c3)C(=O)OC4=O)(C(F)(F)F)C(F)(F)F)ccc21] | 5,5′-(perfluoropropane-2,2- diyl)bis(isobenzofuran-1,3-dione) | 4,4′- (hexafluoroisopropylidene) diphathalic dianhydride (6FDA) |
| 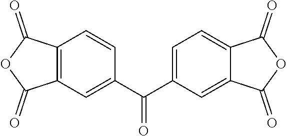 [SMILES: O=C(c1ccc2c(c1)C(=O)OC2=O)c1ccc2c(c1)C(=O)OC2=O] | 5,5′-carbonylbis(isobenzofuran- 1,3-dione) | 3,3′,4,4′- benzophenonetetracarboxylic dianhydride (BTDA) |
| 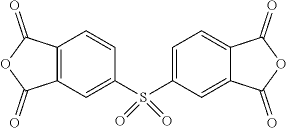 [SMILES: O=C1OC(=O)c2cc(S(=O)(=O)c3ccc4c(c3)C(=O)OC4=O)ccc21] | 5,5′-sulfonylbis(isobenzofuran-1,3- dione) | 3,3′,4,4′- diphenylsulfonetetracarboxylic dianhydride |
| 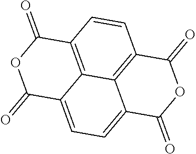 [SMILES: O=C1OC(=O)c2ccc3c4c(ccc1c24)C(=O)OC3=O] | isochromeno[6,5,4- def]isochromene-1,3,6,8-tetraone | 1,4,5,8- Naphthalenetetracarboxylic dianhydride |
| 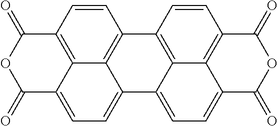 [SMILES: O=C1OC(=O)c2ccc3c4ccc5c6c(ccc(c7ccc1c2c73)c64)C(=O)OC5=O] | anthra[2,1,9-def:6,5,10- d′e′f]diisochromene- 1,3,8,10- tetraone | perylene tetracarboxylic anhydride |
| 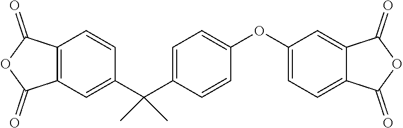 [SMILES: CC(C)(c1ccc(Oc2ccc3c(c2)C(=O)OC3=O)cc1)c1ccc2c(c1)C(=O)OC2=O] | 5-(2-(4-((1,3-dioxo-1,3- dihydroisobenzofuran-5- yl)oxy)phenyl)propan-2- yl)isobenzofuran-1,3-dione | |
| 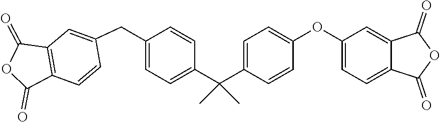 [SMILES: CC(C)(c1ccc(Cc2ccc3c(c2)C(=O)OC3=O)cc1)c1ccc(Oc2ccc3c(c2)C(=O)OC3=O)cc1] | 5,5′-((propane-2,2-diylbis(4,1- phenylene))bis(oxy))bis (isobenzofuran-1,3-dione) | 4,4′-(4,4′)- isopropylidenediphenoxy) bisphthalic dianhydride (BPADA) |

In some aspects, the tetracarboxylic acid dianhydride is selected from the group consisting of pyromellitic dianhydride (PMDA), biphthalic dianhydride (BPDA), oxydiphthalic dianhydride (ODPA), benzophenone tetracarboxylic dianhydride (BTDA), ethylenediaminetetraacetic dianhydride (EDDA), 1,4,5,8-naphthalenetetracarboxylic dianhydride, and combinations thereof. In some aspects, the tetracarboxylic acid dianhydride is PMDA.

The methods as disclosed herein utilize a water-soluble carbonate or bicarbonate salt. The water-soluble carbonate or bicarbonate salt may vary. As used herein, the term “water-soluble” with respect to the salt means that the carbonate or bicarbonate salt has appreciable solubility in water, such that synthetically useful concentrations of the carbonate or bicarbonate anion can be obtained under the conditions utilized in the disclosed method. For example, water-soluble carbonate or bicarbonate salts suitable for use in the disclosed methods may have a solubility in water at 20° C. of at least about 0.1 g per 100 mL, at least about 1 g per 100 mL, or at least about 10 g per 100 mL.

As used herein, the term “carbonate or bicarbonate salt” refers to an alkaline material comprising a carbonate or bicarbonate anion, and specifically excludes alkaline materials comprising carbon-hydrogen covalent bonds (i.e., organic bases, including, but not limited to, alkyl amines, aryl amines, and heteroaromatic amines). Water-soluble carbonate or bicarbonate salts suitable for use in the disclosed method may further be described as non-nucleophilic, meaning that the carbonate or bicarbonate salt does not take part in chemical reactions by donating an electron pair other than as a proton acceptor.

In particular aspects, the water-soluble carbonate or bicarbonate salt is a carbonate. In other particular aspects, the water-soluble carbonate or bicarbonate salt is a bicarbonate. With continued reference to Scheme 1, the water-soluble carbonate or bicarbonate salt has a general formula M₂CO₃ or MHCO₃, where M is a cationic species having a valence of +1.

In some aspects, the cationic species M comprises or is an ammonium ion, a guanidinium ion, or an alkali metal ion. In some aspects, the cationic species M comprises lithium, sodium, potassium, ammonium, guanidinium, or combinations thereof. In some aspects, the cationic species M is lithium. In some aspects, the cationic species M is sodium. In some aspects, the cationic species M is potassium. In some aspects, the cationic species M is ammonium (NH₄⁺). In some aspects, the cationic species M is guanidinium (NH₂—C(═NH₂⁺)—NH₂).

Particularly suitable water-soluble carbonate and bicarbonate salts include those of alkali metals. In some aspects, the water-soluble carbonate or bicarbonate salt is selected from the group consisting of lithium carbonate, lithium bicarbonate, sodium carbonate, sodium bicarbonate, potassium carbonate, potassium bicarbonate, and combinations thereof. In some aspects, the water-soluble carbonate or bicarbonate salt is selected from the group consisting of lithium carbonate, lithium bicarbonate, sodium carbonate, sodium bicarbonate, potassium carbonate, and potassium bicarbonate.

In some aspects, the water-soluble carbonate or bicarbonate salt is selected from the group consisting of ammonium carbonate, ammonium bicarbonate, guanidinium carbonate, and combinations thereof.

The quantity of water-soluble carbonate or bicarbonate salt added may vary, and may depend on, for example, the stoichiometry of the particular salt utilized. For example, one of skill in the art will recognize that depending on the charge associated with the particular anion species (carbonate or bicarbonate) present in the salt. For example, sodium bicarbonate (NaHCO₃) will supply one equivalent of base (bicarbonate ions, HCO₃⁻), each capable of reacting with one proton, and will further provide one equivalent of sodium ions for each molar equivalent of sodium bicarbonate. In contrast, sodium carbonate (Na₂CO₃) will supply two equivalents of base (carbonate ions, CO₃²⁻) capable of reacting with the two equivalents of protons coming from each repeat unit of the polyamic acid, and two equivalents of sodium ions for each molar equivalent of sodium carbonate.

The amount of water-soluble carbonate or bicarbonate salt may be expressed in terms of mole ratio to another reaction component (e.g., diamine). The molar ratio of the water-soluble carbonate or bicarbonate salt to the diamine may require optimization for each set of reactants and conditions. In some aspects, the molar ratio is selected so as to maintain solubility of the polyamic acid. In some aspects, the molar ratio is selected so as to avoid any precipitation of the polyamic acid. In some aspects, the molar ratio of the water-soluble carbonate or bicarbonate salt to the diamine is in a range from about 1 to about 4, or from about 2 to about 3. In some aspects, the molar ratio is from about 1.0, about 1.1, about 1.2, about 1.3, about 1.4, or about 1.5, to about 1.6, about 1.7, about 1.8, about 1.9, or about 2.0. In some aspects, a molar ratio of the water-soluble carbonate or bicarbonate salt to the diamine is from about 2.0 to about 2.6, such as about 2.0, about 2.1, about 2.2, about 2.3, about 2.4, about 2.5, or about 2.6. Without wishing to be bound by any particular theory, it is believed that in some exemplary aspects, at least enough base is required to allow neutralization of substantially all free carboxylic acid groups of the polyamic acid (i.e., form a salt with). In some aspects, the quantity of water-soluble carbonate or bicarbonate salt utilized is the amount which neutralizes substantially all carboxylic acid groups present in the polyamic acid formed during the reaction.

In some aspects, the water-soluble salt is a carbonate, such as lithium, sodium, potassium, ammonium or guanidinium carbonate, and the molar ratio of carbonate ions to the diamine is from about 1.0 to about 1.3.

In some aspects, the water-soluble carbonate or bicarbonate salt is a bicarbonate, such as lithium, sodium, potassium, or ammonium bicarbonate, and the molar ratio of bicarbonate ions to the diamine is from about 2.0 to about 2.6.

In some aspects, the quantity of water-soluble carbonate or bicarbonate salt present may be expressed relative to the carboxylic acid groups of the polyamic acid formed during the reaction or otherwise present in the reaction mixture. In some aspects, the water-soluble carbonate or bicarbonate salt is a bicarbonate, such as lithium, sodium, potassium or ammonium bicarbonate, and the molar ratio of bicarbonate ions to the carboxylic acid groups of the polyamic acid is about 2.0. In some aspects, the water-soluble carbonate or bicarbonate salt is a carbonate, such as lithium, sodium, potassium, or ammonium carbonate, and the molar ratio of carbonate ions to the carboxylic acid groups of the polyamic acid is about 1.0.

The relative quantities of diamine and dianhydride present may be expressed by a molar ratio. The molar ratio of the diamine to the dianhydride may vary according to desired reaction time, reagent structure, and desired material properties. In some aspects, the molar ratio is from about 0.1 to about 10, such as from about 0.1, about 0.5, or about 1, to about 2, about 3, about 5, or about 10. In some aspects, the ratio is from about 0.5 to about 2. In some aspects, the ratio is about 1 (i.e., stoichiometric), such as from about 0.9 to about 1.1. In specific aspects, the ratio is from about 0.99 to about 1.01.

The molecular weight of the polyamic acid may vary based on reaction conditions (e.g., concentration, temperature, duration of reaction, nature of diamine and dianhydride, etc.). The molecular weight is based on the number of polyamic acid repeat units, as denoted by the value of the integer “n” for the structure of Formula III in Scheme 1. The specific molecular weight range of polymeric materials produced by the disclosed method may vary. Generally, the noted reaction conditions may be varied to provide a gel with the desired physical properties without specific consideration of molecular weight. In some aspects, a surrogate for molecular weight is provided in the viscosity of the polyamic acid salt solution, which is determined by variables such as temperature, concentrations, molar ratios of reactants, reaction time, and the like.

The temperature at which the reaction is conducted may vary. A suitable range is generally between about 4° C. and about 100° C. In some aspects, the reaction temperature is from about 15 to about 60° C., such as about 20, about 25, about 30, about 35, about 40, about 45, about 50, about 55, or about 60° C. In some aspects, the temperature is from about 15 to about 25° C. In some aspects, the temperature is from about 50 to about 60° C.

The reaction is allowed to proceed for a period of time and is generally allowed to proceed until all of the available reactants (e.g., diamine and dianhydride) have reacted with one another. The time required for complete reaction may vary based on reagent structures, concentration, temperature. In some aspects, the reaction time is from about 1 minute to about 1 week, for example, from about 15 minutes to about 5 days, from about 30 minutes to about 3 days, or from about 1 hour to about 1 day. In some aspects, the reaction time is from about 1 hour to about 12 hours.

The concentration of the polyamic acid salt in the aqueous solution may vary. For example, in some aspects, the range of concentration of the polyamic acid salt in the aqueous solution is from about 0.01 to about 0.3 g/cm³, based on the weight of the polyamic acid.

### B. Gels of Polyamic Acids (PAA) and Polyimides (PI)

In some aspects, the method further comprises converting the aqueous solution of the polyamic acid salt to the corresponding polyamic acid gel. Generally, the method of converting the polyamic acid salt solution to the corresponding polyamic acid gel comprises acidifying the polyamic acid salt solution to convert the polyamate salt into the polyamic acid, causing phase separation of the polyamic acid as a wet organogel. The acidification to form the polyamic acid generally follows Scheme 2.

The method of acidification may vary. For example, in some aspects, the polyamate salt solution is added to an acid solution, wherein acidification of the polyamate salt solution is rapid. Alternatively, the polyamate salt solution may be acidified by addition of acid to the polyamate salt solution. In some aspects, the polyamate salt solution may be acidified gradually or slowly using conditions or techniques known to one of skill in the art.

The acid used may vary. For example, a mineral acid or an organic may be utilized. For example, suitable acids include, but are not limited to, hydrochloric, sulfuric, or phosphoric acids, or carboxylic acids such as acetic acid. Alternatively, an acid precursor may be utilized, meaning a material which generates acid under certain conditions. One non-limiting example of such an acid precursor is acetic anhydride, which liberates acetic acid upon hydrolysis in contact with water.

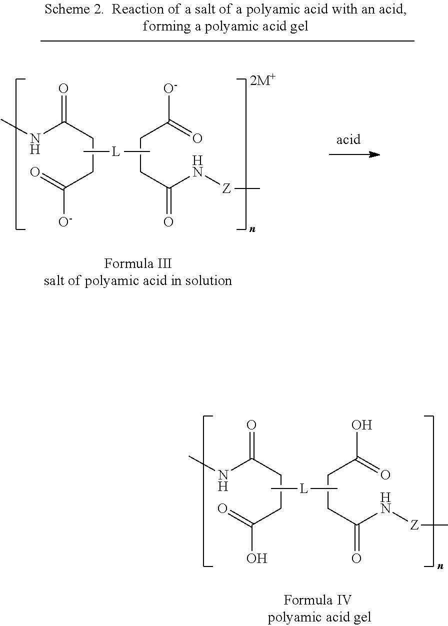

In some aspects, the polyamic acid wet gel prepared as disclosed herein, or the corresponding aerogel as described herein below, comprises residual carbonate or bicarbonate salt(s). Generally, the residual amount is a trace quantity, but the carbonate or bicarbonate, and/or the associated counter cation (e.g., alkali metal ions, guanidinium ions, and the like) may be detected by analytical methods known to one of skill in the art.

The resulting polyamic acid gel material may subsequently be dried to form a polyamic acid aerogel. Methods of acidification and formation of the polyamic acid gel material are described in, for example International Patent Application Publication No. WO2022125835, which is incorporated herein in its entirety. Methods of drying to form the corresponding aerogel are described further herein below.

In some aspects, the method further comprises forming a polyimide aerogel from the aqueous solution of the polyamic acid salt. Generally, the method comprises imidizing the polyamic acid salt to form a polyimide gel; and drying the polyimide gel to form the polyimide aerogel. Methods of imidizing the aqueous solution of the polyamic acid salt are described in, for example International Patent Application PCT/US2021/062706, which is incorporated herein in its entirety, and suitable methods are also described further herein below. Methods of drying to form the corresponding polyimide aerogel are described further herein below.

In some aspects, imidizing the polyamic acid salt comprises thermally imidizing the corresponding polyamic acid. Irradiation of the wet gel polyamic acid material with microwave frequency energy is one particularly suitable thermal treatment. In comparison to conventional heating, which relies on slow thermal conduction, microwave heating allows rapid and efficient energy transfer. Accordingly, microwave heating is particularly suitable for conducting the present thermal imidization reactions. Generally, the microwave frequency irradiation is at a power and for a length of time sufficient to convert a substantial portion of the amide and carboxyl groups of the polyamic acid to imide groups. As used herein in the context of converting the amide and carboxyl groups to imide groups, “substantial portion” means that greater than 90%, such as 95%, 99%, or 99.9%, or 99.99%, or even 100%, of the amide and carboxyl groups are converted to imide groups.

In other aspects, imidizing the polyamic acid salt comprises performing chemical imidization, where chemical imidization comprises adding a gelation initiator to the aqueous solution of the salt of the polyamic acid to form a gelation mixture (a “sol”), and allowing the gelation mixture to gel (e.g., in molds, or cast on sheet, or in other various formats, such as beads). In such aspects, the gelation initiator is added to initiate and drive imidization, forming the polyimide wet gel from the polyamic acid salt.

The structure of the gelation initiator may vary but is generally a reagent that is at least partially soluble in the reaction solution, reactive with the carboxylate groups of the polyamic acid salt, and effective in driving the imidization of the polyamic acid carboxyl and amide groups, while having minimal reactivity with the aqueous solution. One example of a class of suitable gelation initiator is the carboxylic acid anhydrides, such as acetic anhydride, propionic anhydride, and the like. In some aspects, the gelation initiator is acetic anhydride.

In some aspects, the quantity of gelation initiator may vary based on the quantity of tetracarboxylic acid dianhydride or polyamic acid. For example, in some aspects, the gelation initiator is present in various molar ratios with the tetracarboxylic acid dianhydride. In some aspects, the gelation initiator is present in various molar ratios with the polyamic acid. The molar ratio of the gelation initiator to the tetracarboxylic acid dianhydride or polyamic acid may vary according to desired reaction time, reagent structure, and desired material properties. In some aspects, the molar ratio is from about 2 to about 10, such as from about 2, about 3, about 4, or about 5, to about 6, about 7, about 8, about 9, or about 10. In some aspects, the ratio is from about 2 to about 5.

The temperature at which the gelation reaction is allowed to proceed may vary, but is generally less than about 50° C., such as from about 10 to about 50° C., or from about 15 to about 25° C.

The gelation conditions described above (both acidification and imidization) are general and intended to be non-limiting with respect to the manner in which the gelation is performed. For example, one of skill in the art will recognize various permutations in which monoliths or beads, including microbeads are prepared. For example, contemplated herein are methods of forming monoliths by casting the gelling mixture in a mold, methods of forming beads of various sizes by dropping or spraying the polyamic acid salt solution into an acidic receiving solution, or forming micron-sized beads of polyamic acid or polyimide gels in an emulsion.

In some aspects, the polyimide wet gel prepared as disclosed herein, or the corresponding aerogel as described herein below, comprises residual carbonate or bicarbonate salt(s). Generally, the residual amount is a trace quantity, but the carbonate or bicarbonate, and/or the associated counter cation (e.g., alkali metal ions, guanidinium ions, and the like) may be detected by analytical methods known to one of skill in the art.

### C. Aerogels of Polyamic Acids and Polyimides

As noted herein above, in some aspects, the method further comprises converting the polyamic acid salt, via the corresponding polyamic acid or polyimide wet gel, to an aerogel material. Generally, formation of an aerogel comprises drying the wet gel in one or more stages. In some aspects, the wet gel (polyamic acid or polyimide) is aged. Following any aging, the resulting wet gel material, may be collected (e.g., demolded) and washed or solvent exchanged first with water to remove any unreacted organic salts or acids, and then in a suitable secondary solvent to replace the primary reaction solvent (i.e., water) present in the wet gel. Such secondary solvents should be miscible with supercritical fluid carbon dioxide (CO₂) and include linear alcohols with 1 or more aliphatic carbon atoms, diols with 2 or more carbon atoms, or branched alcohols, cyclic alcohols, alicyclic alcohols, aromatic alcohols, polyols, ethers, ketones, cyclic ethers or their derivatives. In some aspects, the secondary solvent is water, a C1 to C4 alcohol (e.g., methanol, ethanol, propanol, isopropanol, or n-, iso-, or sec-butanol), acetone, tetrahydrofuran, ethyl acetate, acetonitrile, supercritical fluid carbon dioxide (CO₂), or a combination thereof. In some aspects, the secondary solvent is ethanol.

Once the wet gel has been formed and processed, the liquid phase of the wet gel can then be at least partially extracted from the wet gel material using extraction methods, including processing and extraction techniques, to form an aerogel material (i.e., “drying”). Liquid phase extraction, among other factors, plays an important role in engineering the characteristics of aerogels, such as porosity and density, as well as related properties such as thermal conductivity. Generally, aerogels are obtained when a liquid phase is extracted from a wet gel in a manner that causes low shrinkage to the porous network and the solid framework of the wet gel. Wet gels can be dried using various techniques to provide aerogels or xerogels. In exemplary aspects, wet gel materials can be dried at ambient pressure, under vacuum (e.g., through freeze drying), at subcritical conditions, or at supercritical conditions to form the corresponding dry gel (e.g., an aerogel, such as a xerogel).

In some aspect, it may be desirable to reduce the surface area of the dry gel. If reduction of the surface area is desired, aerogels can be converted completely or partially to xerogels with various porosities. The high surface area of aerogels can be reduced by forcing some of the pores to collapse. This can be done, for example, by immersing the aerogels for a certain time in solvents such as ethanol or acetone or by exposing them to solvent vapor. The solvents are subsequently removed by drying at ambient pressure.

Aerogels are commonly formed by removing the liquid mobile phase from the wet gel material at a temperature and pressure near or above the critical point of the liquid mobile phase. Once the critical point is reached (near critical) or surpassed (supercritical; i.e., pressure and temperature of the system is at or higher than the critical pressure and critical temperature, respectively) a new supercritical phase appears in the fluid that is distinct from the liquid or vapor phase. The solvent can then be removed without introducing a liquid-vapor interface, capillary forces, or any associated mass transfer limitations typically associated with receding liquid-vapor boundaries. Additionally, the supercritical phase is more miscible with organic solvents in general, thus having the capacity for better extraction. Co-solvents and solvent exchanges are also commonly used to optimize the supercritical fluid drying process.

If evaporation or extraction occurs below the supercritical point, capillary forces generated by liquid evaporation can cause shrinkage and pore collapse within the gel material. Maintaining the mobile phase near or above the critical pressure and temperature during the solvent extraction process reduces the negative effects of such capillary forces. In certain aspects of the present disclosure, the use of near-critical conditions just below the critical point of the solvent system may allow production of aerogels or compositions with sufficiently low shrinkage, thus producing a commercially viable end-product.

Wet gels can be dried using various techniques to provide aerogels. In example aspects, wet gel materials can be dried at ambient pressure, at subcritical conditions, or at supercritical conditions.

Both room temperature and high temperature processes can be used to dry gel materials at ambient pressure. In some aspects, a slow ambient pressure drying process can be used in which the wet gel is exposed to air in an open container for a period of time sufficient to remove solvent, e.g., for a period of time in the range of hours to weeks, depending on the solvent, the quantity of wet gel, the exposed surface area, the size of the wet gel, and the like.

In another aspect, the wet gel material is dried by heating. For example, the wet gel material can be heated in a convection oven for a period of time to evaporate most of the solvent (e.g., ethanol). After partially drying, the gel can be left at ambient temperature to dry completely for a period of time, e.g., from hours to days. This method of drying produces xerogels. Notably, according to the present disclosure, it was found that drying of wet gels in monolithic form resulted in cracking, but wet gels in bead form retained their spherical shape even from lower target-density, Td, solutions (e.g., Td=0.05 g cm³).

In some aspects, the wet gel material is dried by freeze-drying. By “freeze drying” or “lyophilizing” is meant a low temperature process for removal of solvent that involves freezing a material (e.g., the wet gel material), lowering the pressure, and then removing the frozen solvent by sublimation. As water represents an ideal solvent for removal by freeze drying, and water is the solvent in the method as disclosed herein, freeze drying is particularly suited for aerogel formation from the disclosed polyimide wet gel materials. This method of drying produces cryogels, which may closely resemble aerogels.

Both supercritical and sub-critical drying can be used to dry wet gel materials. In some aspects, the wet gel material is dried under subcritical or supercritical conditions. In an example aspect of supercritical drying, the gel material can be placed into a high-pressure vessel for extraction of solvent with supercritical CO₂. After removal of the solvent, e.g., ethanol, the vessel can be held above the critical point of CO₂ for a period of time, e.g., about 30 minutes. Following supercritical drying, the vessel is depressurized to atmospheric pressure. Generally, aerogels are obtained by this process.

In an example aspect of subcritical drying, the gel material is dried using liquid CO₂ at a pressure in the range of about 800 psi to about 1200 psi at room temperature. This operation is quicker than supercritical drying; for example, the solvent (e.g., ethanol) can be extracted in about 15 minutes. Generally, aerogels are obtained by this process.

Several additional aerogel extraction techniques are known in the art, including a range of different approaches in the use of supercritical fluids in drying aerogels, as well as ambient drying techniques. For example, U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels.

In some aspects, extracting the liquid phase from the wet gel uses supercritical conditions of CO₂.

### IV. LFP-Aerogel Conglomerate Particles

### A. Example Process Flow for Conglomerate Particle Synthesis

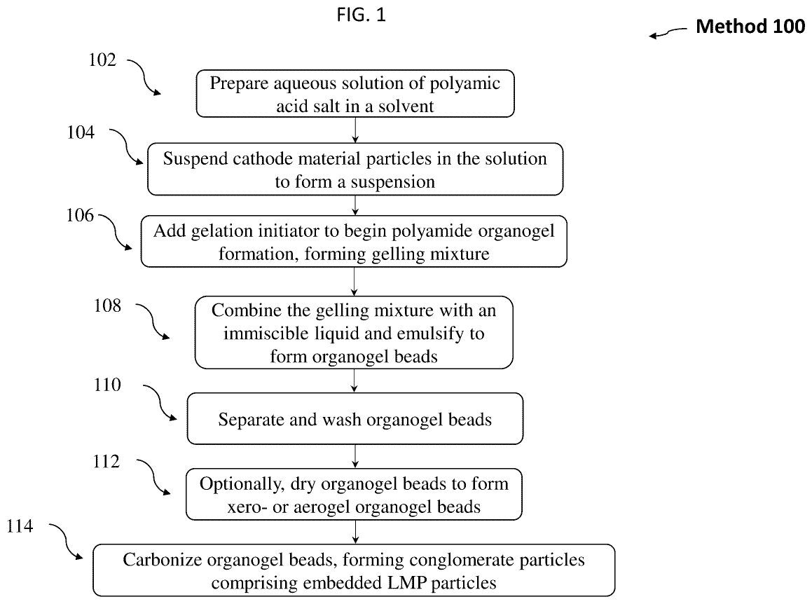

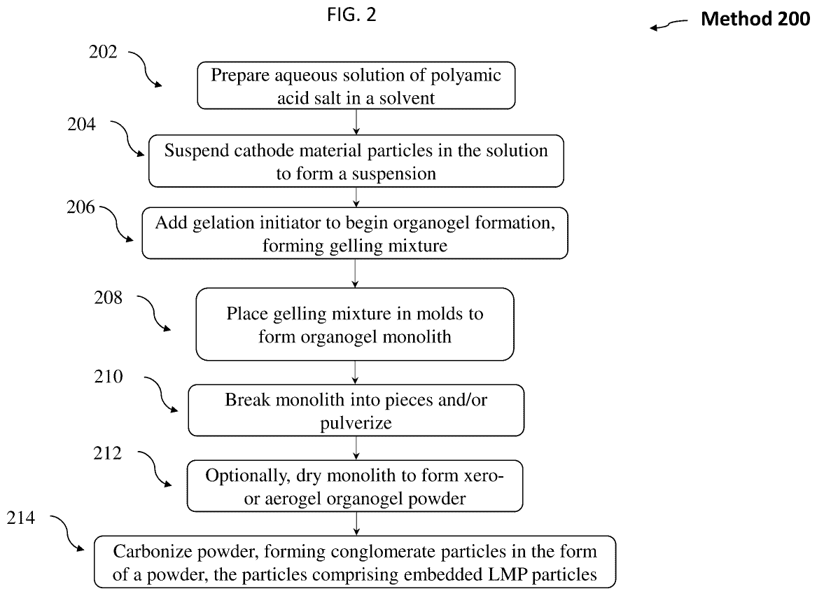

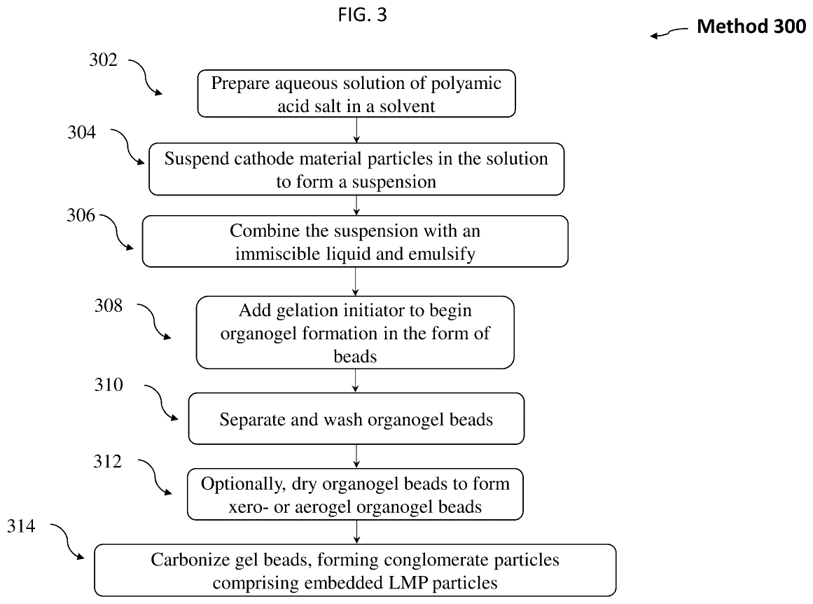

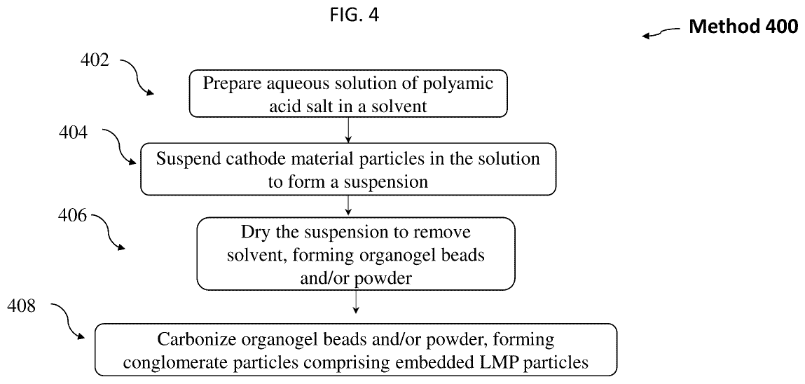

FIG. 1, FIG. 2, FIG. 3, and FIG. 4 are flow diagrams depicting several methods according to non-limiting aspects of the present disclosure. According to FIG. 1, in one aspect a method 100 is used to synthesize conglomerate particles having embedded LMP particles. In step 102 an aqueous solution of polyamic acid salt is prepared and cathode material particles are mixed in at step 104. In step 106, organogel formation to form a polyamide organogel is initiated by the addition of a gelation initiator to the mixture, for example an acid or acid anhydride. The gelling mixture from step 106 is emulsified before formation of the gel is complete in step 108 to form beads which are separated and washed at step 110 after gelation. The beads may then be dried in step 112 to form aerogel or xerogel beads having embedded LMP. The beads are then carbonized in step 114 to form conglomerate particles of the disclosure.

Alternatively, according to the method 200 of FIG. 2, an aqueous solution of polyamic acid salt is prepared in step 202 and particles of cathode material are mixed in at step 204. A gelation initiator, for example an acid anhydride, is added to the mixture in step 206, and the mixture is allowed to form a gel in a mold at step 208. The monolith gel formed in step 208 is broken up in step 210 and is optionally dried in step 212 to form an aerogel or xerogel powder. This powder is carbonized in step 214 to form conglomerate particles according to the present disclosure in the form of a powder.

FIG. 3 illustrates a further alternative method 300 for forming conglomerate particles according to the present disclosure in the form of beads. According to this process 300, an aqueous solution of a polyamic acid salt is prepared at step 302 and particles of cathode material are mixed in in step 304. The mixture is emulsified at step 306 before adding a gelation initiator such as an acid at step 308 to cause the emulsion to gel. At step 310 the beads of gel that are formed are separated and washed before being dried at step 312 to form aerogel or xerogel beads having embedded cathode material particles. These beads are then carbonized at step 314 to form conglomerate particles according to the present disclosure.

A further alternative is illustrated in FIG. 4, labelled process 400. In this aspect, an aqueous solution of polyamic acid salt is prepared at step 402. Particles of cathode material are mixed in at step 404. The mixture is dried in step 406, for example by spray drying, to form intermediate xerogel beads and/or powder. The intermediate xerogel beads and/or powder are then carbonized at step 408 to form conglomerate particles according to the present disclosure

### B. LFP Synthesis

As described herein the LMP (M=metal, also “LFP”) materials discussed herein may comprise, consist of, or consist essentially of a single lithium metal phosphate (e.g., LFP where “F” is iron), or a mixture thereof (e.g., particles of LFP and LVP, where V=vanadium). Alternatively, or in combination, the LFP materials described herein may be continuous solid solutions containing a mixture of transition metals, such as LiFe₁₋ₓMnₓPO₄ (where 0≤x≤1). When the metal is Fe or Mn, the formula is LiMePO₄. When the metal is V, the formula is Li₃V₂(PO₄)₃.

The present disclosure can utilize LMP, including LFP, from any source including commercial sources and including course-grained, low-cost LFP (“LC-LFP”) having large particle size and poor electrochemical performance. However, for illustration an outline method of synthesizing LMP is also provided.

LMP may be synthesized from metal oxide precursor materials. For M=Fe, the precursor of choice is natural or artificial Fe₂O₃ for cost, availability and low-toxicity reasons. For M=Mn, the precursor could be either MnO, Mn₂O₃, MnO₂, or a combination thereof. For M=V, the precursor could be either V₂O₃, VO₂, V₂O₅, or a combination thereof. When the precursor metal oxide has an average oxidation state greater than 2.0 for Mn and Fe precursors, or 3.0 for V precursors (i.e., everything described in this paragraph except MnO and V₂O₃), a carbon source is needed during LFP synthesis for quantitative and stoichiometric reduction of the metal to the Me(II) oxidation state.

The choice of carbon source varies from different polymer sources, such as synthetic polymers (polyarylamide, polyimide, polyamide, polybenzoxazine (PBO), phenol-formaldehyde, RF, polyvinyl pyrrolidone, polyethylene oxide, polyethylene), biopolymers (starch, cellulose) modified biopolymers (alginic acid, cellulose acetate, carboxymethylcellulose [CMC], sucrose-citrate polyester), biomass, or simple mono- or disaccharides (sucrose, glucose, fructose).

For the case of LiMnPO₄ with synthesis from MnO as precursor, no extensive reduction by a carbon source is needed due to the Mn(II) oxidation state. In such a case, a thickening agent such as CMC or alginic acid is added up to 0.5% (by weight with respect to MnO) to keep the ingredients in the suspended state throughout the drying step, and to provide extra protection against occasional oxidation in the heating step (e.g., O₂ leakage or impurities in the carrier gas).

In each case and depending on the choice of carbon source, an appropriate amount of carbon source is added so that the residual carbon content of the bulk LMP is 0.1-3 wt. %.

A typical LMP synthesis proceeds as follows: H₃PO₄ 85%, H₂O (1:1 to 10:1 weight ratio to oxide source), Li₂CO₃, metal oxide, and carbon source/thickening agent are added in any order to a reaction vessel and with a molar ratio of Li:Fe:P of 1:1:1. Mixing can be done using a variety of techniques such as overhead mechanical mixing, high-speed blade mixer, ultrasonic mixer, recirculating mixer, and the mixing time is one quarter hour to 10 hours.

Drying can be done in a variety of formats such as hot plate, air oven, forced hot gas dryer (air or N₂), conveyor belt oven, vacuum oven, tumble dryer, or a combination of above. Drying temperature is in the range of RT to 200° C.

The dried LMP is then heat treated in the temperature range of 300-1000° C. and different heating methods can be employed, for example conventional furnace (convection/conduction), microwave furnace or induction furnace. The heating duration varies based on the heating method, from minutes to hours. Short heating is employed in microwave and induction heating while longer heating times are used with conventional furnaces. Heating and cooling rates can be 1-1000° C./min, depending on the heating method.

The furnace atmosphere can be static or dynamic with gas flow or vacuum. In case of gas flow, inert (Ar or N₂) or reductive (H₂—Ar or H₂—N₂ with a hydrogen content of 5-10% mol) gas mixtures can be used at a flow rate of 10 mL/min-10 L/min per kg of the reaction charge. If a reducing atmosphere is present, proportionally lower amounts of reducing C will be needed.

Heating can be done also in the air with provisions for minimizing 02 leakage into the reaction mixture, such as a muffle furnace under nitrogen purge or a closed furnace with an inert or reducing gas blanket. In such cases, an oxygen scavenger such as carbon felt can be used on top of the reaction charge to minimize LMP/C oxidation.

### C. LMP Milling

Pulverization of the LMP to reduce particle size can be done in a variety of mill machines such as a roller mill, planetary ball mill or high-speed bead agitator mill using milling media such as alumina, zirconia, and stainless steel. The milling time can vary from minutes (high-energy mills) to hours (lower energy mills). The rotation can be varied from 60-10000 rpm, depending on the method.

Milling can be performed in dry or wet formats. For a wet milling method, the bulk LMP powder is dispersed in a liquid phase chosen from water, ethanol, isopropanol, ethylene glycol, acetone, or a mixture thereof. The liquid/solid weight ratio can vary from 0.5:1 to 10:1. The milling media (balls or rings) to solid weight ratio can vary from 5:1 to 100:1.

The milling can be performed in the air or under inert gas atmosphere and in static (batch) or dynamic (flow) modes with single or multi-circuit passes. In the case of wet milling, the resultant milled slurry can be used directly for mixing in with the polyamic acid salt or is dried according to one of the methods discussed above, i.e., using a hot plate, air oven, forced hot gas dryer (air or N₂), conveyor belt oven, vacuum oven, tumble dryer, or a combination of these, with a drying temperature in the range of ambient (e.g., about 20° C.) to 200° C. The dispersant can be recycled and reused if needed. In case of wet milling, milling can be done with or without surfactants. The surfactants can vary in 0.1-5% wt. with respect to the solid bulk LMP charge.

After milling, the desired mean particle size of the LMP is less than 250 nm, such as less than 150 nm, referring to D50 as described herein.

### D. Dispersing LMP in Gel Precursor

The aqueous solution of a polyamic acid salt is prepared as described above. Any method described herein can be used to prepare the aqueous solution of a polyamic acid salt as the first step in the disclosed methods. For example, the polyamic acid salt may be prepared in situ from the appropriate diamine and tetracarboxylic acid dianhydride in water as described herein, or the polyamic acid may be prepared separately in a non-aqueous solvent (e.g., dimethylformamide or dimethylacetamide), and dissolved in water using a water-soluble carbonate or bicarbonate salt, also as described herein. The present inventors have found that of the methods disclosed herein, particularly advantageous results may be obtained when using guanidinium and/or lithium carbonate or bicarbonate salts to form the aqueous solution of the polyamic acid salt.

Dispersion of nanoscale LMP in the gel precursor solution (i.e., aqueous solution of polyamic acid salt) can be achieved using a variety of methods such as a high-speed mixer, high-shear mixer, ball-mill, or rotary mixer. The solid-liquid mixing ratio, polymer solution concentration, polymer chemistry choice, and mixing conditions are discussed in the worked examples. Generally, the mixing conditions are selected based on multiple factors including scale, organogel type, concentration thereof, and the like. Generally, the mixing is conducted for a period of time and under conditions sufficient to disperse the LMP material in the gel precursor solution.

For example, in some aspects, the mixing is performed at a speed of at least about 500 rpm, such as from about 500 to about 5000 rpm. In some aspects, the mixing is performed at a higher speed such as from about 1000 to about 9000 rpm using, e.g., a homogenizer. Particularly, such high speed mixing is utilized when the method comprises forming an emulsion to produce in bead form the organogel having dispersed therein the LMP. In some aspects, the mixing is performed for a period of time in a range from about 1 minute to about 30 minutes, such as from about 1 to about 3, about 4 to about 15, or about 5 to about 10 minutes. One of skill in the art will recognize that the speed of mixing and time of mixing may be varied depending on the desired degree of dispersion/emulsification desired.

According to the present disclosure, it has been found that the viscosity of the gel precursor plays a role in providing particularly advantageous conglomerate particles. In particular, the density of the gel precursor solution should be sufficient to maintain the nanoscale LMP particles in dispersion and separated from each other such that they remain separated from each other in the resulting organogel. A concentration of around 0.05 g/cm³ (mass polymer precursor solute per gram water) may be particularly advantageous to provide adequate dispersion of the LMP particles.

It is also possible to mill the bulk LMP powder in the polyamic acid salt aqueous solution. In this case the “Milling” and “Dispersion” steps are merged, and no separate dispersion is needed. This is because of the high affinity of the polyelectrolyte nature of the polyamic acid solution to wet the oxide-terminated surfaces of the pulverized LMP particles.

The disclosed method includes the step of mixing cathode material, which includes LMPs (e.g., iron, manganese, vanadium, combinations thereof), to the aqueous solution of polyamic acid salt to form a slurry. The slurry is later gelled and then dried to form an aerogel or xerogel. The amount of LMP to be included in the slurry depends on the targeted ratio of LMP to aerogel in the final product. While the LMP can be obtained from any source, as described above, and preferably from a low-cost source (LC-LFP), it is important in the context of this disclosure that the LMP be added to form the slurry in nano-scale particles. These can be obtained by milling the bulk LMP material, for example reducing the average particle size of a commercial product from micron scale to submicron and nanoscale.

Milling can be conducted using wet or dry processes. In dry milling processes, powder is added to a vessel, together with milling media. The milling media typically includes balls or rods of zirconium oxide (yttrium stabilized), silicon carbide, silicon oxide, quartz, or stainless steel. The particle size distribution of the resulting milled material is controlled by the energy applied to the system and by matching the starting material particle size to the milling media size. However, dry milling is an inefficient and energy consuming process. Wet milling is similar to dry milling with the addition of a milling liquid. An advantage of wet milling is that the energy consumption for producing the same result is 15-50% lower than for dry milling. A further advantage of wet milling is that the milling liquid can protect the milling material from oxidizing. It has also been found that wet milling can produce finer particles and result in less particle agglomeration. Accordingly, in some aspects, the method comprises wet milling.

Wet milling can be performed using a wide variety of liquid components. In other aspects, the milling liquid or components included in the milling liquid are selected to provide a desired surface chemical functionalization of the particles, e.g., the LFP particles, during or after milling. The milling liquid or components included in the milling liquid can also be selected to control the chemical reactivity or crystalline morphology of the particles, e.g., the LFP particles. In exemplary aspects, the milling liquid or components included in the milling liquid can be selected based on compatibility or reactivity with downstream materials, processing steps or uses for the particles, e.g., the LFP particles. For example, the milling liquid or components included in the milling liquid can be compatible with, useful in, or identical to the liquid or solvent used in a process for forming or manufacturing organic or inorganic aerogel materials. In yet another aspect, the milling liquid can be selected such that the milling liquid or components included in the milling liquid produce a coating on the LFP particle surface or an intermediary species, such as an aliphatic or aromatic hydrocarbon, or by cross-linking or producing cross-functional compounds, that react with the organic or inorganic aerogel material.

In some aspects, the solvent or mixture of solvents used for wet milling can be selected to control the chemical functionalization of the particles during or after milling. In some aspects, the LMP can conveniently be milled in situ in the solution of polyamic acid salt used to form gels in the disclosed methods. In this particular aspect of the method, it is not necessary to perform a separate step of dispersing milled LMP particles in the solution of polyamic acid salt because this is already achieved in the grinding process. The polyamic acid solution can wet the oxide-terminated surfaces of the ground LMP particles and achieve excellent and uniform dispersion of the LFP particles in the slurry.

### E. Gelling to Form an Organogel

Processes for forming an organogel by gelling the aqueous solution of polyamic acid salt are described herein in the section entitled “Preparing polyamic acid and polyimide gel materials under aqueous conditions” and any of these methods may be used to form gels of the present disclosure from the aqueous slurry of polyamic acid salt solution and LMP. The following processes 1, 2, 3 are configurable for the synthesis of aerogel microbeads and/or xerogel microbeads. Aerogel and/or xerogel microbeads can be selected for production in these processes by tailoring processing temperatures, solvents, solvent evaporation rate, reaction rate, drying rate, and other factors to either preserve wet gel porosity or reduce wet gel porosity (e.g., via pore collapse during drying).

i. Process 1: beads of polyimide (PI) gel

Nano-size LMP from milling is dispersed uniformly in an adequate amount (depending on the targeted LMP/C aerogel ratio) of an aqueous solution of polyamic acid salt, using a high-speed mixer for 5-15 min at 1000-5000 rpm.

Acetic anhydride is added to the resulting slurry as a gelation initiator and the mixture is poured into an aqueous-non-miscible medium (i.e., a dispersant medium such as mineral spirit, hexane, heptane, kerosene, octane, or other hydrocarbons), and the mixture is emulsified (using a homogenizer) at a high rate (1000-9000 rpm). During this process, micron-size (5-30 μm) LMP/PI wet gel beads are formed. The emulsion process lasts 4-15 min.

The LMP/PI wet gel bead synthesis can be performed in the presence or absence of surfactant. If used, the surfactant is dissolved in the non-miscible dispersant medium (1-2% wt.), prior the addition of the acidified LMP/polyamic acid salt solution slurry.

The dispersant medium is separated from the beads mainly through decantation. The dispersant can be recycled. LMP/PI gel beads are rinsed several times with ethanol to remove any trace of dispersant medium. Subsequently the LMP/PI gel beads are converted into LMP/PI aerogel or xerogel beads by drying.

ii. Process 2: Beads of Polyamic Acid (PAA) Gel

For LMP/PAA bead synthesis, the above slurry is poured into a non-aqueous, water-immiscible dispersant medium (mineral spirit, hexane, heptane, kerosene, octane, or other hydrocarbons), and emulsified (using a homogenizer) at high rate (1000-9000 rpm). After 1-3 minutes of mixing (during which micron-size (5-30 μm) liquid beads are formed from the aqueous slurry), and acetic acid or acetic anhydride is added to the mixture (while mixing) to induce gelation of the formed beads.

The LMP/PAA bead synthesis can be performed in the presence or absence of surfactant. If used, the surfactant is dissolved in the dispersant medium (1-2% wt.), prior the addition of LMP/polyamic slurry. The dispersant medium is separated from the beads mainly through decantation. The dispersant can be recycled. LMP/PAA gel beads are rinsed several times with ethanol to remove any trace of dispersant medium. Subsequently the LMP/PAA gel beads are converted into LMP/PAA aerogel or xerogel beads by drying.

iii. Process 3: Polyimide (PI) Gel Monolith

Nano-sized LMP from milling, is dispersed uniformly in adequate amount (depending on the targeted LMP/C aerogel ratio) of aqueous polyamic acid salt solution, using a high-speed mixer for 5-15 min at 1000-5000 rpm. The resulting slurry is gelled by adding the appropriate amount of acetic anhydride while mixing (using mechanical, magnetic, or other means of mixing). The wet monolith gel (LMP/PI) may be crushed into small gel chunks (mm size) prior supercritical drying (to form aerogel) or conventional ambient drying (to form xerogel)

The obtained LMP/PI aerogel (or xerogel) material can be further pulverized into powders consisting of micron-size particles (<50 μm) using a low-energy grinder. Overall, the mean particle size D50 of the beads or particles produced by processes 1, 2 and 3 is advantageously 0.5 to 20 microns, and preferably from around 1 micron to 10 micron, for example 5 micron. It is believed that particle sizes of less than 1 micron, while easily dispersed in the liquid binder/carbon additive during electrode casting, and easily cast as films of uniform thickness by blade-casting techniques, leading to more reproducible aerial density needed for anode/cathode pairing, suffer from certain disadvantages (too small is difficult to work with due to dusting, static charges, etc., and generally lead to a lower tap density of the powder (shape dependent) and lower energy density). In contrast, particle sizes greater than 10 microns are difficult to cast uniformly, leading to variations in the aerial capacity of the electrode, and have a grainy/rough appearance leading to possible separator puncture during cell assembly, stack pressure application.

### F. Spray Drying

The following process has been found experimentally to produce primarily xerogel microbeads. In an alternative method according to the present disclosure the aqueous solution of polyamic acid salt does not undergo the gelation process described above. Instead, the LMP particles are dispersed in the aqueous solution of a polyamic acid salt as described above and the resulting slurry is spray-dried using techniques known in the art. This involves atomising the slurry with heating to produce small droplets with relatively large surfaces area which dry quickly. This results in beads of the dried droplets comprising the cathode material particles and polymer. Conglomerate particles having a size of 5 to 30 μm may be obtained by controlling the nozzle of the spray drying equipment as well as the relative flow rates of the feed (the slurry) and the drying gas. In this manner the conglomerate particles that are formed comprise particles of cathode material at least partially encapsulated by polymer from the solution.

### G. Carbonizing

In some aspects, the method further comprises converting the organogel (e.g., a polyamic acid or polyimide aerogel) to an isomorphic carbon aerogel, the converting comprising pyrolyzing the respective aerogel under suitable conditions. Accordingly, in some aspects, the method further comprises pyrolyzing (e.g., carbonizing) a polyamic acid or polyimide aerogel as disclosed herein, meaning the aerogel is heated at a temperature and for a time sufficient to convert substantially all of the organic material into carbon. As used herein in the context of pyrolysis, “substantially all” means that greater than 95% of the organic material is converted to carbon, such as 99%, or 99.9%, or 99.99%, or even 100% of the organic material is converted to carbon. Pyrolyzing the organic aerogel converts the aerogel to an isomorphic carbon aerogel in which the physical properties (e.g., porosity, surface area, pore size, diameter, and the like) are substantially retained in the corresponding carbon aerogel.

The time and temperature required for pyrolyzing may vary. In some aspects, the polyimide aerogel is subjected to a treatment temperature of about 600° C. or above, such as about 600° C., about 650° C. about 700° C., about 750° C., about 800° C., about 850° C., about 900° C., or about 950° C., or in a range between any two of these values, for carbonization of the aerogel. Generally, the pyrolysis is conducted under an inert atmosphere to prevent combustion of the organic or carbon material. Suitable atmospheres include, but are not limited to, nitrogen, argon, or combinations thereof. In some aspects, pyrolysis is performed under nitrogen.

The conglomerate particles produced by the above methods, for example comprising aerogels, xerogels or spray dried particles are further carbonised as described above. This entails heating the materials for a time sufficient to convert substantially all of the organic material (polymer) into carbon. As described above, the pyrolyzing (carbonisation) can take place at various temperatures above 650° C. and as high as 1000° C. According to the present disclosure, it was found that a temperature of 800° C. may be a particularly advantageous for pyrolyzing the disclosed conglomerate particles. When pyrolyzing an aerogel or xerogel which does not have embedded cathode materials, higher temperatures can be used. However, in the case of the cathode materials described herein, such as lithium metal phosphate particles, there is risk that elevated temperatures, unwanted crystals of the LMP material may form, which may lead to a reduction in electrochemical performance. However, according to the present disclosure, it was found that the porous nature of the polymer network surrounding the LMP in the conglomerate particles inhibits these undesirable changes in crystal structure. Thus, according to the present disclosure, carbonization can take place at temperatures from about 650° C. to about 1000° C., or from 650° C. to about 800° C. The carbonization time may depend on the temperature used; for example, carbonization at around 800° C. may take place over a time period of 5-10 hours, for example 8 hours, whereas carbonization at lower or higher temperatures may require respectively more or less time for the carbonization to proceed to its fullest extent (i.e., all organic gel converted to carbon).

It is possible according to the present disclosure to tailor the amount of carbon in the final conglomerate particles. For example, in some aspects, it is desirable to prepare conglomerate particles having a percentage of carbon suitable for use in Li ion batteries, wherein the amount of carbon is sufficient to provide necessary conductivity to the LMP without being too abundant and therefore creating dead space/mass which cannot hold charge in the final battery. Commercial LFP-carbon materials may contain around 3% carbon and therefore around 97% LFP.

The percentage carbon in the conglomerate particles may be calculated using the formula:

$$\\ \% C \approx \frac{\begin{matrix}mass of precursor \times concentration of precursor \times \\ carbonization yield\end{matrix}}{mass of LMP}$$

wherein “mass of precursor” refers to the mass of the aqueous gel precursor solution, “concentration of precursor” refers to mass of the polymer solute in grams per mass of the aqueous gel precursor solution, and “carbonization yield” is the fraction of the polymer in the formed gel which is converted to carbon during carbonization. The carbonization yield may vary in the range of around 0.3 to 0.4 depending on the specific process and materials that are used.

By way of example, taking 50 g organogel precursor having a concentration of 0.05 g per g of solution and a carbonization yield of 0.4, with 10 g LMP leads to a conglomerate particle having 9% C and 91% LMP. The formula above calculates only the carbon which results from carbonization of the polymer gel. There may be additional leftover carbon from the LMP synthesis process which also contributes to carbon in the conglomerate particle. This is expected to be up to around 4% and is expected to be less than 1% (for example, 0.5%).

### H. Material Characteristics

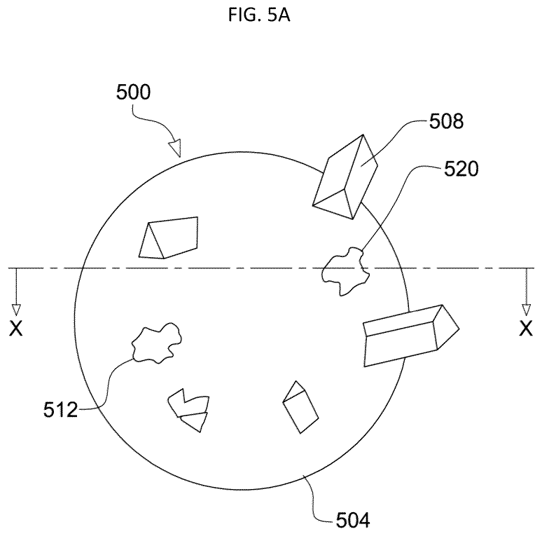

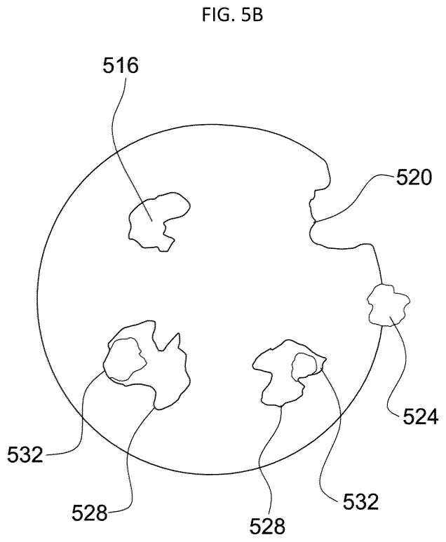

A representation of a conglomerate particle 500 according to the present disclosure is shown in FIGS. 5A and 5B. The particle 500 is substantially spherical and porous as shown in FIG. 5A, which is a perspective view and which shows visible pores 512, 520 on the surface of the particle. It is also evident from FIG. 5A that there are partially embedded LFP particles 508 which protrude to some degree into the core 504 of the particle 500.

FIG. 5B is a cross section through the dotted line X-X in FIG. 5A and shows the same vacant surface pore 520 as well as a vacant internal pore 516. FIG. 5B also illustrates occupied internal pores 528 which contain completely embedded LFP particles 532. FIG. 5B also illustrates an LFP particle 524 which is partially embedded and therefore protruding through the surface of the conglomerate particle 500.

Overall, the conglomerate particles of the present disclosure have a high internal surface area which may be above 50 m²/g or above 100 m²/g in substantially spherical particles. Bead sizes may be 0.5 to 50 μm, 5 to 30 μm or 1 to 10 μm. Pore size of the conglomerate particle may be around 1-50 nm, such as from about 10 to about 20 nm.

The conglomerate particles (e.g., in the form of beads) include cathode material particles (e.g., comprising LMP) at least partially embedded in the porous carbon matrix. In other words, some of the cathode material (e.g., LMP) particles are completely embedded within the matrix particle, whereas other cathode material (e.g., LMP) particles protrude from or on the surfaces of the matrix particle.

The cathode material (e.g., LMP) particles at least partially embedded in the porous carbon matrix are isolated from each other by the porous carbon network, meaning while the cathode material (e.g., LMP) particles may be in close proximity, they are not generally in direct contact with one another (i.e., not touching each other).

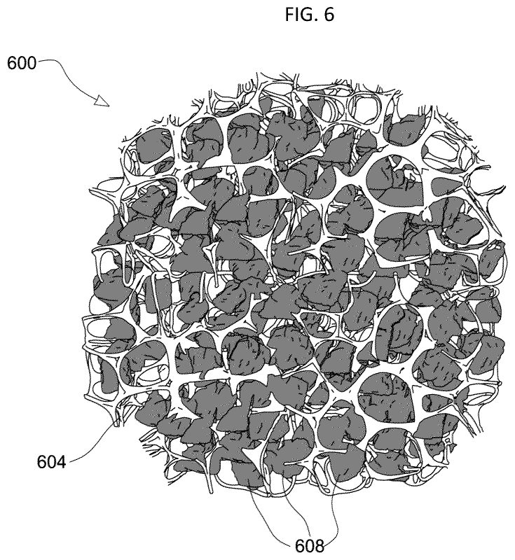

FIG. 6 schematically illustrates a conglomerate particle 600 according to the present disclosure, having a carbon network 604 which surrounds LFP particles 608. While FIG. 6 is merely illustrative, it can be appreciated again that the LFP particles 608 are kept spaced apart by the carbon network 604 and that some LFP particles are completely embedded within particle 600 whereas other LFP particles are partially embedded and are visible on the surface of particle 600.

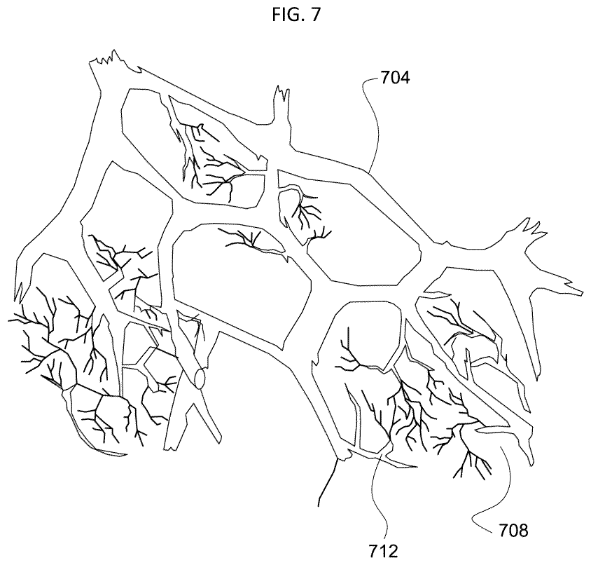

The carbon matrix may have a fibrillar structure i.e., comprising fibrils as described above. There may be a hierarchy of carbon fibrils within the matrix. FIG. 7 illustrates in more detail the carbon network 604 of FIG. 7. As shown in FIG. 7, the carbon network 704 branches into fibrils 712 at the surfaces of the LMP particles 708. In some aspects, the fibrils 721 making contact with the LFP surface may be thinner and have a higher density than the fibrils that are not in contact with the LFP particles. Without wishing to be bound by theory, it is believed that the thinner, higher density fibrils at the surfaces of the LMP particles help to coat the surfaces of the LFP particles and improve conductivity.

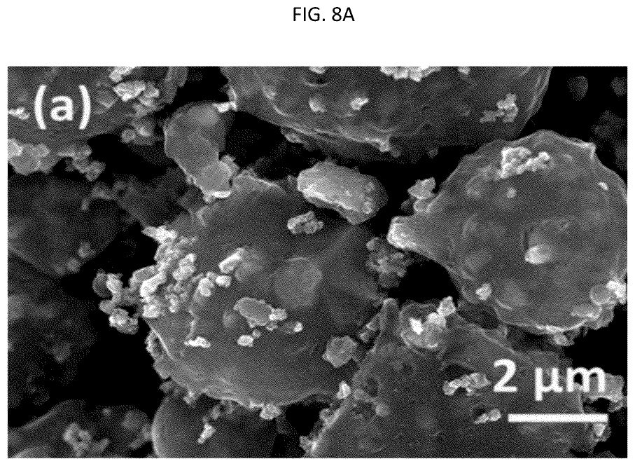

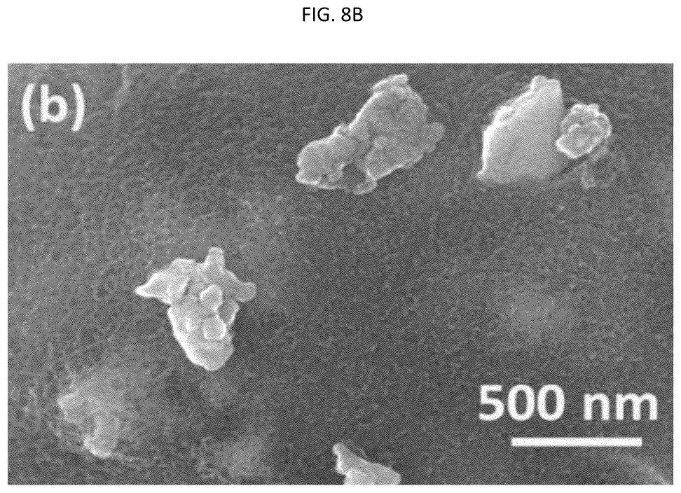

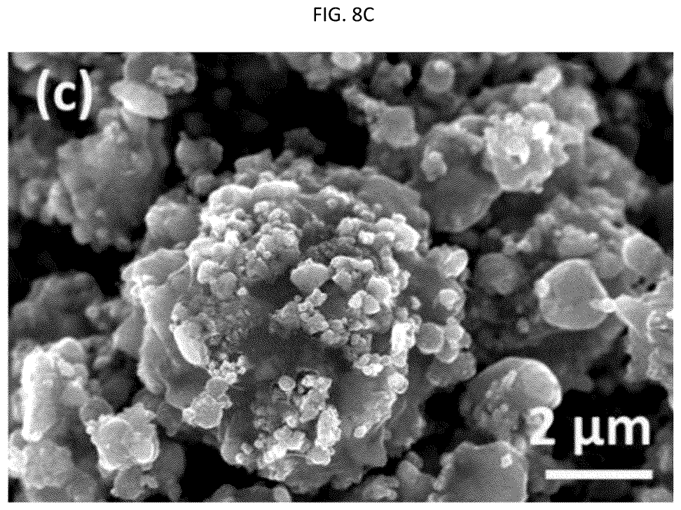

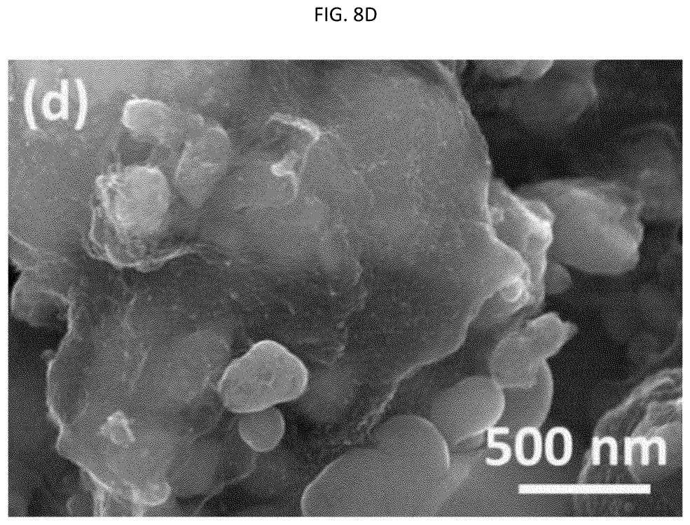

FIGS. 8A-8D comprises four scanning electron micrographs of conglomerate particles according to the present disclosure. FIG. 8A and FIG. 8B show conglomerate particles having a mass ratio of 75:25 LFP:carbon, whereas FIG. 8C and FIG. 8D have a mass ratio of 90:10 LFP:carbon. Magnifications are 10,000 times for FIG. 8A and FIG. 8C, and 50,000 times for FIG. 8B and FIG. 8D. Like schematic FIGS. 5A and 5B, SEM FIGS. 8A-8D shows substantially spherical conglomerate particles having embedded LFP particles visible on the surfaces.

### I. Electrochemical Properties

The conglomerate particles of the present disclosure surprisingly act as very high-performance cathode materials with fast ionic and electronic transfer rates. This is at least partly due to the well-separated LFP particles in a conductive carbon matrix, and the avoidance of unwanted LFP crystal growth when carbonizing the gels.

The starting LC-LFP materials used in this disclosure may have a capacity of around 20 mAh/g. After being ground, this capacity may improve slightly to around 80 mAh/g. The conglomerate particles of the present disclosure, which comprise LFP particles, can achieve a capacity in excess of 140 mAh/g, up to around 160 mAh/g.

As explained above, in existing prior art LFP materials it is commonplace to add a small amount of carbon to improve conductivity of the poorly conducting LFP materials. The amount of carbon should be minimised because carbon addition amounts to dead space, i.e., mass of a battery cell which cannot hold charge. Thus, commercial LFP-C materials may include around 3% carbon. Conglomerate particles of the present disclosure can be produced with different amounts of carbon such as 10% or less, 5% or less, 3% or less carbon, with the remainder being LMP, by varying the amount of the carbon precursor (polymer) during production as explained above.

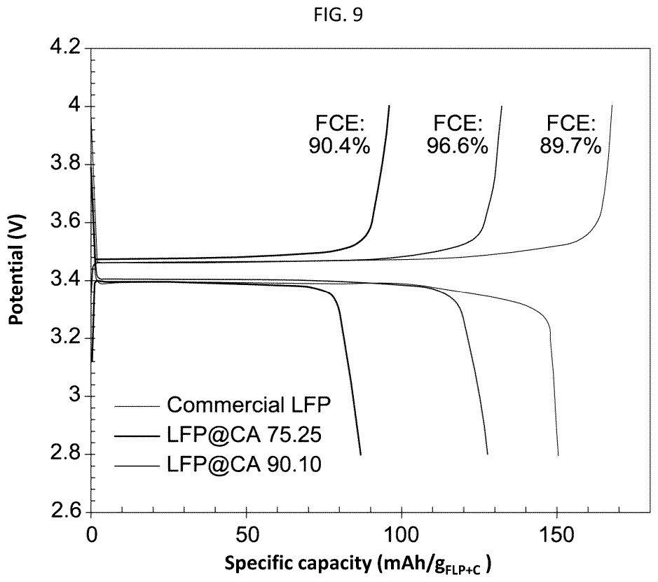

Experimentation has shown that conglomerate particles of the disclosure may have an overall capacity (normalized for the mass of LMP and carbon) of around 130 mAh/g at a charge rate of C/20, even when containing a relatively high amount of carbon (such as 10%; see e.g., FIG. 9 and the discussion thereof herein below). This approaches the charging capacity for commercially obtainable LFP-C taken as the test control, which was used as received. Moreover, the conglomerate particles of the disclosure have an improved first-cycle coulombic efficiency (FCE) as compared with the control sample.

It is expected that for conglomerate particles according to the disclosure, having lower amounts of carbon will achieve higher capacity of 140 mAh/g and above, such as 150-160 mAh/g, because reducing the carbon content reduces the dead mass, as described herein above.

The conglomerate particles of the present disclosure have an excellent capacity retention. When used as cathode materials the conglomerate particles retain capacity extremely well as C-rate is increased and have a capacity retention of over 80% at a C-rate of 1C in half-cells. On the other hand, the control LFP particles lose around 50% capacity at 1C, i.e., only a 50% charge retention.

The conglomerate particles of the disclosure also exhibit an extremely good cycle life. The materials of the present invention show absolutely no capacity loss even after hundreds of charging cycles whereas prior art products are expected to lose about 75% of their initial capacity in direct comparison.

The conglomerate particles of the disclosure show an additional increase of the practical capacity of LFP by more than 50% compared to just pulverised LFP, so that capacities exceeding 145 mAh/g become achievable for LFP materials, even when starting from a low quality, low performance and inexpensive bulk LFP. A further unexpected benefit of the conglomerate particles is a high rate performance of at least 80% capacity retention at 1C compared to C/20. Thirdly, the materials of the disclosure exhibit outstanding cycle life with no capacity loss after 300 cycles at 1C charge-discharge rate in half-cells with metallic lithium anode.

### EXPERIMENTAL EXAMPLES

Two examples of synthesis of LFP/carbon aerogel materials in accordance with the present disclosure are described.

### J. LC-LFP Synthesis

Starting material 100 g of LC-LFP was prepared as follows: 51.9 g of bulk iron oxide (Fe₂O₃) was stirred in 200 ml of water for 30 min. To this slurry, 74.94 g of phosphoric acid (85%) was added and mixed for 30 min. Then, 25.22 g of Li₂CO₃ was added stepwise to the mixture. The resulting slurry was further mixed for 1 hour.

Separately, a polyamate salt solution was prepared by dissolving 1,4-phenylenediamine (PDA; 14.86 g) in 808 g of water, followed by addition of triethylamine (TEA: 33.44 g, 46.09 mL, 2.4:1 mol/mol ratio to PDA or PMDA) and PMDA (pyromellitic dianhydride 29.97 g, 0.138 mol, 1:1 mol/mol ratio relative to PDA). A 75.0 g portion of the resulting aqueous polyamate solution was added to the inorganic mixture (as a source of carbon for Fe₂O₃ reduction) and mixed vigorously. The resulting slurry was heated up to 130° C. while mixing to remove the water. Once completely dried, the LFP precursor solid was crushed to fine powder before heat-treatment at 800° C. for 8 h under inert gas. The obtained LFP exhibited a primary particle size ranging between 1 and 10 μm, and poor specific capacity of 20 mAh/g. This LC-LFP was ball-milled for 10 h to reduce the particle size <500 nm before its use for LFP/carbon aerogel synthesis according to the present disclosure. After ball-milling, the specific capacity of the pulverized LFP was improved to about 80 mAh/g.

### II. LFMnP (Fe:Mn=2:1) Synthesis

Step 1: Preparation of the mixed oxide precursor. Ferrous sulfate (FeSO₄·7H₂O, 90.6 g) and Manganese sulfate (MnSO₄·H₂O, 27.5 g) were dissolved in deionized water and mixed for 30 minutes. This solution was added in a dropwise manner to a solution of oxalic acid (90.0 g in 500 mL H₂O), leading to an immediate formation of mixed metallic oxalate salt, Fe_{2/3}Mn_{1/3}C₂O₄·2H₂O. After complete addition, the precipitate was filtered and washed with water multiple time. After drying, the solid powdered by calcined in an air furnace at 350° C. for 1 hour, causing its oxidative decomposition to the mixed oxide, spinel MnFe₂O₄. Separately, an aqueous polyamate salt solution was prepared by dissolving PDA (14.86 g) in 808 g of water, followed by the addition of triethylamine (TEA: 33.44 g, 46.09 mL, 2.4:1 mol/mol ratio to PDA or PMDA) and PMDA (29.97 g, 0.0.138 mol, 1:1 mol/mol ratio relative to PDA).

Step 2: Preparation of LFMnP. The resulting mixed oxide from Step 1 was crushed into a fine powder and was stirred in 200 mL of water for 30 min. Phosphoric acid (85%, 56.3 g) was added to this suspension, and the mixture was mixed for 30 min. Then, Li₂CO₃ (19.0 g) was added stepwise to the mixture, followed by the addition of 37.5 g of the above polyamate solution to the oxide inorganic mixture (as a source of carbon for the reduction of the trivalent iron), and the mixture was mixed vigorously. The resulting slurry was heated up to 130° C. while mixing to remove the solvent (water). The dry mixed oxides precursor was crushed to a fine powder, and was heated at 800° C. for 8 h under an inert gas.

### III. LVP Synthesis

Bulk LVP was prepared as follows: Vanadium(V) oxide (V₂O₅, 29.6 g) was stirred in 100 mL of water for 30 min. Phosphoric acid (85%, 56.30 g) was added to this suspension, and the mixture was mixed for 30 min. Then, Li₂CO₃ (18.9 g) was added stepwise to the mixture. The resulting slurry was mixed for 1 h. Separately, a polyamate salt solution was prepared by dissolving PDA (14.86 g) in 808 g of water, followed by addition of triethylamine (TEA: 33.44 g, 46.09 mL, 2.4:1 mol/mol ratio to PDA or PMDA) and PMDA (29.97 g, 0.138 mol, 1:1 mol/mol ratio relative to PDA). A 75.0 g portion of the above polyamate solution was added to the inorganic mixture (as a source of carbon for the reduction of V₂O₅), and the slurry was mixed vigorously. The new slurry was heated up to 130° C. while mixing to remove the solvent (water). The dry LVP precursor was crushed to a fine powder, and was heated at 800° C. for 8 h, under an inert gas.

### IV. Aqueous Preparation of LFP/Carbon Micron-Sized Aerogel Beads at Different Weight Ratios

Micron-size LFP/polyamic acid gel beads were prepared via gelation of an aqueous lithium salt solution of polyamic acid in emulsions. The target density of the polyamic precursor solution was fixed to be around 0.05 g/cm³ and was prepared by dissolving PDA (14.86 g) in 808 g of water, followed by lithium carbonate (12.13 g; 1.2:1 mol/mol ratio to PDA or PMDA) and the mixture was stirred for 5-15 minutes. PMDA (29.97 g, 0.138 mol, 1:1 mol/mol ratio relative to PDA) was added to the mixture, and the mixture was stirred for 24-48 hours at room temperature. The resulting aqueous carbonate salt solution of the polyamic acid had a viscosity at room temperature of around 400-500 cP.

Two different materials (having 75/25 and 90/10 weight ratios of LFP/micron-size carbon aerogel beads) were prepared by the sol-gel method. The synthetic procedure started with dispersing milled LC-LFP in the previously prepared polyamic precursor solution. The amount used was determined based on the carbon yield (˜43%) of the polyimide aerogel after carbonization, LFP carbon ratio, and the amount of LC-LFP used. For the nominal 75/25 ratio sample, 6 g of LC-LFP was mixed with 100 g of polyamic precursor solution, and for the nominally 90/10 ratio sample, 6 g of LC-LFP was mixed with 40 g of polyamic precursor solution.

The LC-LFP/polyamic precursor solution mixture was mixed in the presence of 2.5 mm zirconia beads (10 g of beads for 50 g of mixture) for 5 minutes at 2500 rpm using a high-shear mixer to assure a better dispersion of the LFP in polyamic precursor solution in the resultant slurry.

Acetic anhydride (3.21 g, 2.97 mL, 4.3 mol/mol ratio relative to PMDA in the polyamic acid for the 75/25 material; or 1.28 g, 1.19 mL, 4.3 mol/mol ratio relative to PMDA in the polyamic acid for the 90/10 material) was added to the resulting LFP/polyamic slurry and stirred magnetically for 60 seconds. At the end of that period, the precursor solution was poured into an immiscible phase under shear using a Ross mixer at 4000 rpm. The immiscible phase was prepared by dissolving 8.35 g of surfactant (Hypermer® H70), in 500 mL of mineral spirits. The precursor solution was added to the mineral spirits phase at a 1:4 v/v ratio. After stirring under high shear for 4-5 minutes, the mixture was removed from the Ross mixer and left to stand for 1-3 hours.

The lower density phase (mineral spirit solution) was decanted. The gel beads were collected using filtration under reduced pressure, and they were solvent-exchanged with ethanol three times. The ethanol-exchanged (washed) gel beads were dried using supercritical CO₂ and are referred to as 75/25 and 90/10 LFP/PI aerogel beads.

Heat treatment of the two materials was performed at 800° C. for 8 h under flowing nitrogen using a heating ramp and cooling rates of 5° C./min and 1° C./min, respectively to carbonize the aerogel materials.

### V. LFP/Carbon Aerogel Characteristics and Performance

### Structural and Textural Properties

The 75/25 and 90/10 materials (the Figures herein refer to these ratios of LFP/carbon aerogel) developed relatively high surface area of 126 m²/g and 58 m²/g, respectively, as measured by the BET surface area analysis method.

As shown in FIGS. 8A-8D, SEM micrographs clearly show the sphericity of conglomerate 75/25 material with a bead size ranging from 1 to 10 m and well dispersed LFP within carbon aerogel framework. For the LFP/CA 90/10 material, the sphericity of micro-composites is reduced as the lower amount of PI polymer did not contain the LFP aggregates completely. Still, well-separated LFP particles in porous carbon aerogel are evident.

### Electrochemical Performance.

The LFP-carbon conglomerate particles were cast as cathode onto an Al foil current collector and used as the cathode in coin-cell size half-cells. For comparison purposes, half-coin-cells with cathode comprising commercial LFP (purchased from Landt Instruments) were assembled under identical conditions and subjected to galvanostatic charge-discharge cycling at various C-rates.

FIG. 9 shows the voltage profiles and first-cycle coulombic efficiency (FCE) of the three LFP-carbon conglomerate particles. Evidently, the commercial LFP-C provides the highest capacity of 150 mAh/g with an FCE slightly lower than 90%. Among the LFP-carbon conglomerate particles, the LFP-carbon conglomerate particles 90:10 (LFP:carbon) shows a higher specific capacity at 130 mAh/g with an excellent FCE of over 96%. On the other hand, LFP-carbon conglomerate particles 75:25 shows lower a specific capacity of below 90 mAh/g with an FCE just above 90%. The lower specific capacity and FCE of the high-carbon variant of LFP-carbon conglomerate particles is due to the larger amounts of carbon, which contributes to the dead-mass, higher side reactions, and surface blockage.

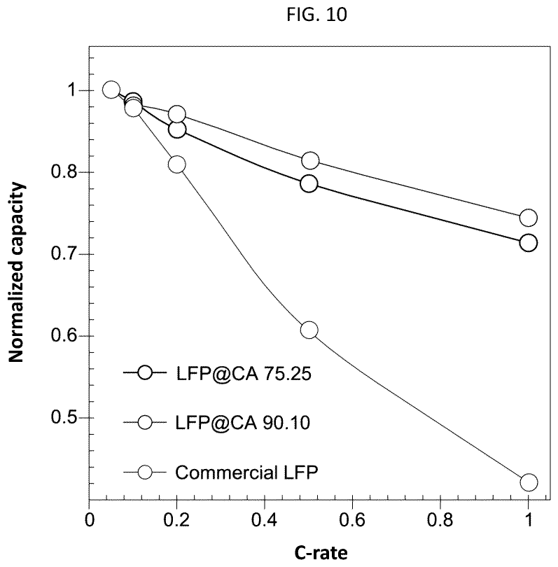

FIG. 10 shows the high-rate performance of the LFP-carbon conglomerate particle cathodes, compared with the commercial LFP. In both LFP-carbon conglomerate particles electrodes, the capacity retention as the C-rate increases from C/20 to 1C is above 80%, whereas for the commercial LFP the capacity decreases by about 50%. Thus, the LFP-carbon conglomerate particles of the present disclosure have excellent high-rate performance.

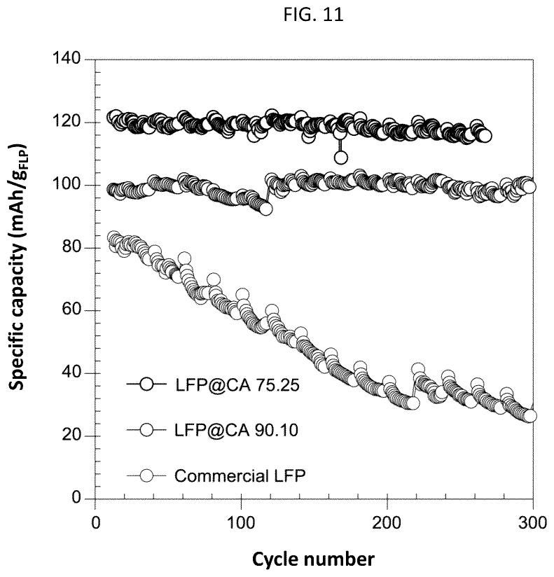

FIG. 11 shows the cycle-life of the LFP-carbon conglomerate particle electrodes at 1C cycling rate and compares it with that of the commercial product. Evidently, the LFP-carbon conglomerate particle electrodes suffer absolutely no capacity loss after 300 cycles, while the commercial sample lost about 75% of its initial capacity over the same period. This demonstrates the outstandingly good cycle resilience of the products of the present disclosure at high rates.

In this application, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of aspects. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

When used in this specification and claims, the terms “comprises” and “comprising” and variations thereof mean that the specified features, steps or integers are included. The terms are not to be interpreted to exclude the presence of other features, steps or components. The invention comprises, consists of or consists essentially of the disclosed and claimed features.

The invention may also broadly consist in the parts, elements, steps, examples and/or features referred to or indicated in the specification individually or collectively in any and all combinations of two or more said parts, elements, steps, examples and/or features. In particular, one or more features in any of the aspects, examples and aspects described herein may be combined with one or more features from any other aspects, examples and aspects described herein.

Protection may be sought for any features disclosed in any one or more published documents referenced herein in combination with the present disclosure.

Although certain example aspects of the invention have been described, the scope of the appended claims is not intended to be limited solely to these aspects. The claims are to be construed literally, purposively, and/or to encompass equivalents.

1-72. (canceled)

73. A conglomerate particle comprising:
a matrix particle having a pore structure, the matrix particle comprising a carbonized organogel aerogel or xerogel; and
a plurality of cathode material particles at least partially embedded within the matrix particle,
wherein the plurality of cathode material particles comprises lithium metal phosphate (LMP) particles, and wherein at least some of the cathode material particles of the plurality have an average particle size D50 of less than 250 nm.

74. The conglomerate particle of claim 73, wherein the metal (M) of the LMP is selected from the group consisting of Fe, Mn, V, and a combination of Fe and Mn.

75. The conglomerate particle of claim 73, wherein the matrix particle has a particle size of from 100 nm to 20 microns.

76. The conglomerate particle of claim 73, wherein at least some of the cathode material particles of the plurality have an average particle size D50 of less than 150 nm.

77. The conglomerate particle of claim 73, wherein the matrix particle has a specific internal surface area corresponding to internal pores from 50 m²/gram to 150 m²/gram.

78. The conglomerate particle of claim 73, wherein the aerogel of xerogel is formed as a bead or beads or as a monolith.

79. The conglomerate particle of claim 73, wherein the aerogel or xerogel is derived from an organogel comprising a polyimide, a polyamic acid, or a combination thereof.

80. The conglomerate particle of claim 73, wherein the pore structure comprises a fibrillar morphology comprising struts of carbonized material with a width in a range from about 2 to about 10 nm.

81. The conglomerate particle of claim 73, wherein the matrix particle has a substantially uniform pore size distribution.

82. The conglomerate particle of claim 73, wherein the matrix particle has a mean pore size from about 1 to about 50 nm, or from about 5 to about 25 nm.

83. The conglomerate particle of claim 73, wherein the matrix particle comprises pores, and wherein at least a portion of said pores are configured to accommodate the cathode material particles.

84. The conglomerate particle of claim 73, wherein a weight ratio of carbon in the matrix material to the cathode material is less than 30:70, less than 10:90, or less than 5:95.

85. A method of preparing a conglomerate particle comprising a porous carbon matrix particle with a plurality of cathode material particles at least partially embedded within the matrix particle, wherein the porous carbon matrix comprises an aerogel or xerogel, and wherein the cathode material particles comprise at least one lithium metal phosphate (LMP), wherein the metal (M) is selected from iron, manganese, vanadium, and a combination of iron and manganese, the method comprising:
(a) preparing an aqueous solution of a salt of a polyamic acid, wherein preparing the aqueous solution of the salt of the polyamic acid comprises:
combining in water a water-soluble diamine, a water-soluble carbonate or bicarbonate salt, and a tetracarboxylic acid dianhydride; and
allowing the components to react, providing the solution of the salt of the polyamic acid;
(b) mixing cathode material particles with the aqueous solution of the salt of the polyamic acid;
(c1) gelling the mixture of step (b) to form an organogel comprising dispersed cathode material particles, and drying the organogel of step (c1) to form a dried intermediate; or
(c2) drying the mixture of step (b) to form a dried intermediate; and
(d) carbonizing the dried intermediate to form the conglomerate particle.

86. The method of claim 85, wherein the combining comprises:
dissolving a water-soluble diamine in water to form an aqueous diamine solution;
adding the water-soluble carbonate or bicarbonate salt to the aqueous diamine solution;
adding a tetracarboxylic acid dianhydride to the aqueous solution of the diamine and the water-soluble carbonate or bicarbonate salt to form a solution; and
stirring the solution for a period of time in a range from about 1 hour to about 4 days at a temperature in a range from about 4 to about 60° C.

87. The method of claim 85, wherein the combining comprises:
dissolving a water-soluble diamine in water to form an aqueous diamine solution;
adding a tetracarboxylic acid dianhydride to the aqueous diamine solution to form a suspension;
stirring the suspension for a period of time in a range from about 1 hour to about 4 days at a temperature in a range from about 4 to about 60° C.;
adding the water-soluble carbonate or bicarbonate salt to the suspension; and
stirring the suspension for a period of time in a range from about 1 hour to about 4 days at a temperature in a range from about 4 to about 60° C. to provide the aqueous solution of the salt of the polyamic acid.

88. The method of claim 85, wherein the combining comprises:
adding to water, simultaneously or in rapid succession, a water-soluble diamine, a tetracarboxylic acid dianhydride, and the water-soluble carbonate or bicarbonate salt; and
stirring the resulting mixture for a period of time in a range from about 1 hour to about 4 days at a temperature in a range from about 4 to about 60° C. to provide the aqueous solution of the polyamic acid salt.

89. The method of claim 85, wherein the water-soluble carbonate or bicarbonate salt comprises lithium, sodium, potassium, ammonium, or guanidinium cations.

90. The method of claim 85, wherein the water-soluble carbonate or bicarbonate salt is selected from the group consisting of lithium carbonate, lithium bicarbonate, sodium carbonate, sodium bicarbonate, potassium carbonate, potassium bicarbonate, ammonium carbonate, ammonium bicarbonate, guanidinium carbonate, and combinations thereof.

91. The method of claim 85, wherein:
the water-soluble carbonate or bicarbonate salt is a carbonate, and a molar ratio of the water-soluble carbonate salt to the diamine is from about 1 to about 1.4; or
the water-soluble carbonate or bicarbonate salt is a bicarbonate, and a molar ratio of the water-soluble bicarbonate salt to the diamine is from about 2 to about 2.8.

92. The method of claim 85, wherein the cathode material particles comprise or consist essentially of LiFePO₄.

93. A conglomerate particle comprising a porous carbon matrix particle with a plurality of cathode material particles at least partially embedded within the matrix particle, obtained by or obtainable by the method of claim 85.
